(19) United States
(12) Patent Application Publication
(10) Pub. No.: US 2025/0068305 A1
(43) Pub. Date: Feb. 27, 2025

(54) TAB GROUPING FOR AN APPLICATION

(71) Applicant: Google LLC, Mountain View, CA (US)

(72) Inventors: Mark Chang, Seattle, WA (US); Shuo Meng, Seattle, WA (US); Mingpu Hu, San Francisco, CA (US); Aina Rubies Espinalt, San Francisco, CA (US); Katherine Chen, Seattle, WA (US); Sophie Chang, Seattle, WA (US); Michael Blair Crouse, Seattle, WA (US); David Jacob Pennington, Seattle, WA (US); Tarun Bansal, Seattle, WA (US)

(21) Appl. No.: 18/814,136

(22) Filed: Aug. 23, 2024

Related U.S. Application Data
(60) Provisional application No. 63/578,355, filed on Aug. 23, 2023.

(51) Int. Cl. G06F 3/0483; G06F 3/04847; G06F 16/957

(52) U.S. Cl. CPC G06F 3/0483; G06F 3/04847; G06F 16/9577

(57) ABSTRACT

An application may generate tab information about tabs opened on a user device. An application may identify a tab group from the tabs, the tab group including at least two tabs determined to be related based on the tab information. An application may generate a label for the tab group based on at least a portion of the tab information. An application may modify a tab strip to include the label and the tab group.

### CROSS REFERENCE TO RELATED APPLICATION

This application claims priority to U.S. Provisional Application No. 63/578,355, filed on Aug. 23, 2023, the disclosure of which is incorporated by reference herein in its entirety.

### BACKGROUND

Some browsers allow users to organize tabs into a tab group. Browsers include a tabbed interface, where a web page can be displayed in a separate browser tab. A user may manually add tabs to a tab group or create a new tab group. For example, to create a new tab group, a user may determine which open tabs form part of a group, and then manually add those tabs to a new tab group.

### SUMMARY

This disclosure relates to a tab manager that improves tab organization through programmatic tab grouping and labeling. Programmatic tab grouping may cluster browser tabs into groups based on their semantic similarities, where browser tabs in the same group share a common theme. Labeling may generate a descriptive short text label, and, in some examples, an icon (e.g., an emoji) for a respective group. It is noted that the techniques discussed herein are not limited to browser tabs of a browser application but may encompass any application with a tab interface. As such, in the examples discussed herein, a browser tab can be replaced with a tab. A tab in a tabbed interface may be a visual element that represents a distinct section or view within a larger container, where the tab can display application content (e.g., web content, non-web content, etc.).

In some aspects, the techniques described herein relate to a method including: generating tab information about tabs opened on a user device; identifying a tab group from the tabs, the tab group including at least two tabs determined to be related based on the tab information; generating a label for the tab group based on at least a portion of the tab information; and modifying a tab strip to include the label and the tab group.

In some aspects, the techniques described herein relate to an apparatus including: at least one processor; and a non-transitory computer-readable medium storing executable instructions that cause the at least one processor to execute operations, the operations including: generating tab information about tabs opened on a user device; identifying a tab group from the tabs, the tab group including at least two tabs determined to be related based on the tab information; generating a label for the tab group based on at least a portion of the tab information; and modifying a tab strip to include the label and the tab group.

In some aspects, the techniques described herein relate to a non-transitory computer-readable medium storing executable instructions that cause at least one processor to execute operations, the operations including: generating tab information about tabs opened on a user device; identifying a tab group from the tabs, the tab group including at least two tabs determined to be related based on the tab information; generating a label for the tab group based on at least a portion of the tab information; and modifying a tab strip to include the label and the tab group.

The details of one or more implementations are set forth in the accompanying drawings and the description below. Other features will be apparent from the description and drawings.

### BRIEF DESCRIPTION OF THE DRAWINGS

FIG. 1A illustrates an example interface with a callout affordance for initiating a tab organizer according to an aspect.

FIG. 1B illustrates a tab group interface according to an aspect.

FIG. 1C illustrates a tap strip updated with a tab group according to an aspect.

FIG. 1D illustrates a system for organizing open browser tabs into one or more tab groups according to an aspect.

FIG. 1E illustrates an example of a triggering engine according to an aspect.

FIG. 1F illustrates an example of a tab information according to an aspect.

FIG. 1G illustrates a tab organization service with a tab manager and a tab organizer according to an aspect.

FIGS. 2A to 2C illustrate various examples of callout affordances according to an aspect.

FIG. 3 illustrates an example of a tab group interface according to an aspect.

FIG. 4 illustrates an example of a tab group interface according to another aspect.

FIG. 5 illustrates an example of a tab group interface according to another aspect.

FIGS. 6A to 6B illustrate an example of a tab group interface according to another aspect.

FIGS. 7A to 7D illustrate various aspects of tab group interfaces and tab strips according to an aspect.

FIG. 8 illustrates an example of a tab group interface according to an aspect.

FIG. 9 illustrates an example of a tab group interface according to another aspect.

FIG. 10 illustrates an example of a tab group interface according to an aspect.

FIG. 11 illustrates an example of a tab group interface according to another aspect.

FIG. 12 illustrates an example of a tab group interface according to another aspect.

FIGS. 13A to 13C illustrate examples of a callout affordance and a tab group interface according to an aspect.

FIGS. 14A and 14B illustrate an example of invoking a tab organization service from a browser menu according to an aspect.

FIG. 15 illustrates a high-level diagram of a system for implementing a tab organization service according to an aspect.

FIG. 16 illustrates a data diagram of an example system for generating tab group suggestions according to an aspect.

FIG. 17 illustrates a flowchart depicting example operations of organizing browser tabs into tab groups according to an aspect.

### DETAILED DESCRIPTION

This disclosure relates to a tab manager for an application (e.g., a browser application) that executes a tab organization service (e.g., a tab manager, a tab organizer) configured to suggest one or more tab groups for a user. A tab group includes two or more related tabs (e.g., subject matter displayed in each tab is semantically related to each other). For example, the tab manager may initiate a similarity analysis on open browser tabs on a user device, determine whether some of the open browser tabs are semantically related to each, and, if so, can suggest a tab group (or multiple tab groups) for creation in a tab group interface. The tab group interface includes, for each suggested tab group, two or more semantically related browser tabs and a label (e.g., a short phrase and/or icon (e.g., an emoji)) that describes the subject matter of the related browser tabs. In some examples, the tab manager suggests tab groups from open tabs within the same browser window. In some examples, the tab manager suggests tab groups from open tabs across browser windows. The tab manager may implement a technical solution that programmatically suggests one or more tab groups, and, when created, modify a window management structure to insert the tab group(s) in a secure manner. Although some examples use browser tabs of a browser application, the techniques discussed herein may be applicable to any application using a tabbed interface such as a document editing application, a project management application, a code editor application, a media player application, or an image editing application. A tab in a tabbed interface may be a visual element that represents a distinct section or view within a larger container, where the tab can display application content (e.g., web content, non-web content, etc.).

If a first browser tab in a first browser window displays a first website about the United States' basketball game against Serbia, and a second browser tab in the first browser window or a second browser window displays a second website about the United States' basketball game against France, the tab manager determines that the first and second browser tabs are semantically related and generates a label such as “USA basketball.” The label may be generated using a model (e.g., a language model) that is inputted with tab information about the open browser tabs. In response to selection of a tab creation option on the tab group interface, the tab manager may modify a tab strip to include the label and the tab group. The label can be part of an affordance that can be toggled, e.g., collapsing the tabs in the tab group when selected a first time and expanding the tabs in the tab group when selected a second time, etc.

In some examples, the tab manager may be expressly invoked by the user. For example, the tab manager may receive a selection of a control (e.g., organize similar tabs) displayed in a browser window. In some examples, a user can right-click on the tab strip, which renders a menu with an option to “organize similar tabs.” In some examples, the tab manager can proactively suggest a callout affordance that enables the user to invoke the tab manager to programmatically group the tabs. In some examples, the tab manager may render a callout affordance in response to one or more triggers such as certain actions the user takes with respect to tabs or bookmarks, etc.

The tab manager generates tab information (e.g., titles, resource locators (e.g., uniform resource locators (URLs), and/or content of web pages displayed in the open browser tabs) and uses the tab information to cluster the open browser tabs into one or more groups, where each group includes two or more semantically related tabs. In some examples, the tab manager includes (or communicates with) a clustering engine. The clustering engine may include an embedding model configured to generate embeddings about the web pages using the tab information, and the clustering engine may compute similarity scores based on the embeddings, and cluster a subset of the open browser tabs based on the similarity scores. An embedding is a mathematical representation of attributes of the tab, the web page displayed in the tab, or both. Put another way, the embedding encodes information in a manner that enables fast and efficient comparisons (similarity measures). In some examples, the tab manager includes (or communicates with) a generative model to generate a label about the group, where the label includes a very short phrase and an icon. The generative model can include a language model that operates on and generates text and/or a language model that operates on images and text, e.g., a multi-modal model. In some examples, the generative model uses the tab information (or a portion thereof) to generate the label. A tab group interface identifies the suggested group along with the label. Then, the user can select an option, on the tab group interface, to create the group, which causes the tab group to be identified in the tab strip.

The display of the tabs of the tab group together in the tab strip with a label for the tab group produces the technical benefit of assisting the user in finding and selecting a tab of interest even though the browser may have truncated the name of the tab when displaying it due to limited display area. This can allow the user more readily to find (and then select) a tab of interest even though the browser may be displaying many tabs, each with a relatively small amount of display area allocated for icons and text.

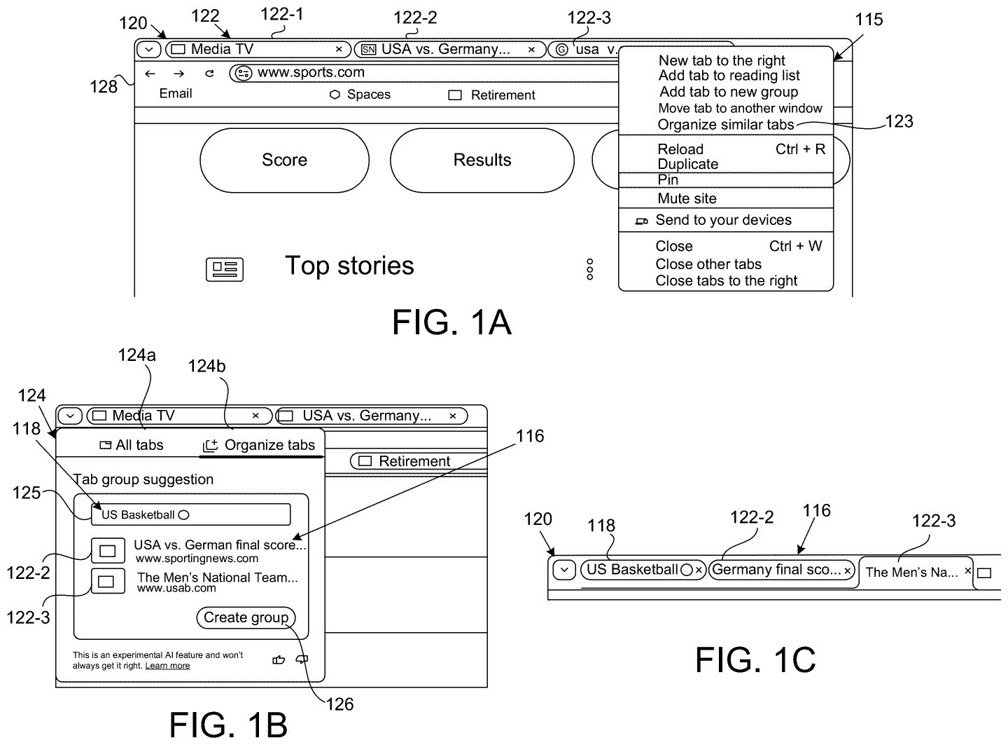

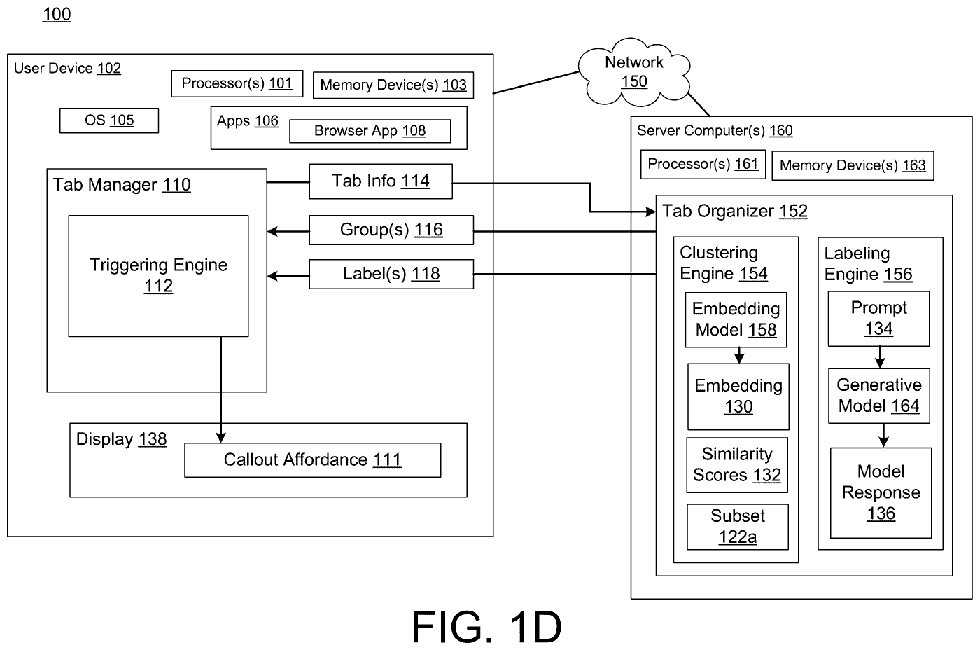

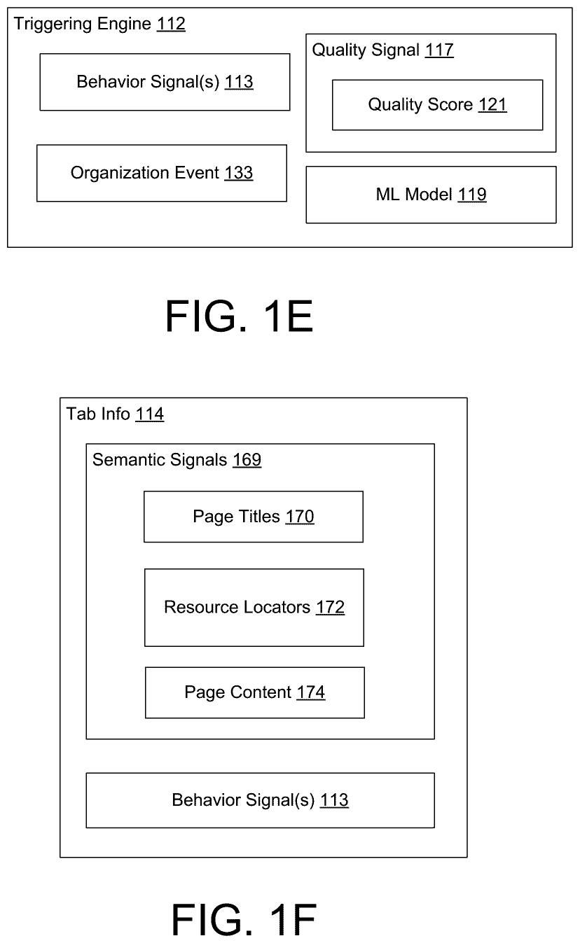

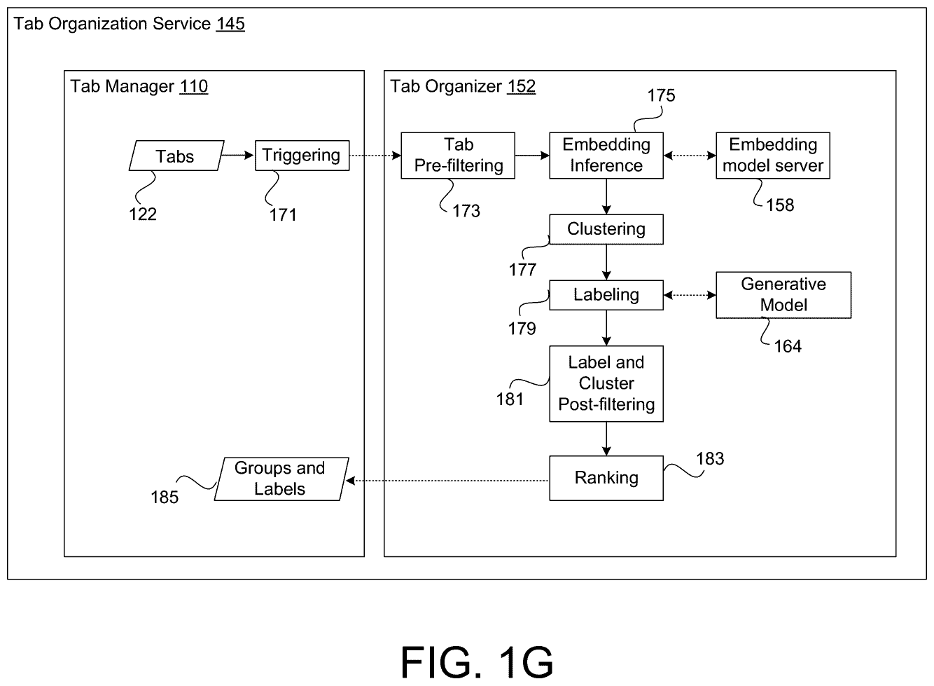

FIGS. 1A to 1G illustrate a system 100 that implements a tab organization service 145 (e.g., a tab manager 110, a tab organizer 152) configured to suggest one or more tab groups 116 for a user by analyzing tab information 114 of browser tabs 122 opened on a user device 102. As shown in FIG. 1A, a browser window 128 includes a tab strip 120 with a plurality of browser tabs 122 such as a browser tab 122-1, a browser tab 122-2, and a browser tab 122-3. In some examples, the tab organization service 145 may provide one or more technical benefits of increased security for communicating with one or more predictive models and/or reduced computing resources (e.g., central processing unit (CPU), memory devices) for executing a similarity analysis. Although some examples use browser tabs 122 of a browser application 108, the techniques discussed herein may be applicable to any application 106 using a tabbed interface such as a document editing application, a project management application, a code editor application, a media player application, or an image editing application. A tab in a tabbed interface may be a visual element that represents a distinct section or view within a larger container, where the tab can display application content (e.g., web content, non-web content, etc.).

As shown in FIG. 1A, a tab manager 110 of a browser application 108 may detect a user selection of an organize control 123 to initiate the tab organizer 152 to organize the browser tabs 122 into one or more tab groups 116. In some examples, the organize control 123 is displayed in a tab menu 115. In some examples, in response to detection of a user command (e.g., a right-click selection) on a browser tab 122 (e.g., any of the browser tabs 122) in the tab strip 120, the tab manager 110 may display a tab menu 115. The tab menu 115 may include the organize control 123 and other tab management operations such as creating a new tab to the right/left, adding a tab to a reading list, moving a tab to another window, pin, mute site, etc.

The organize control 123 may be an example of a callout affordance 111 (as shown in FIG. 1D) configured to activate, and/or notify a user about the feature(s) of the tab organizer 152. Generally, the callout affordance 111 may be a user interface element, such as a menu item, a clickable element, hover element, or a pop-out object or interface. The tab manager 110 may display the callout affordance 111 in an area of a browser window 128 that is viewable and/or discoverable by the user. In some examples, the callout affordance 111 is displayed in the tab strip 120. In some examples, the callout affordance 111 is overlaid on the user interface of the browser window 128.

In some examples, as shown in FIG. 1D, the tab manager 110 includes a triggering engine 112 that selectively displays the callout affordance 111 in response to the detection of an organization event 133. In other words, in response to the detection of an organization event 133, the triggering engine 112 may display the callout affordance 111 to prompt/nudge the user. In some examples, the triggering engine 112 may detect an organization event 133 using one or more behavior signal(s) 113 with respect to browser tabs 122. In some examples, the triggering engine 112 includes a machine-learning (ML) model 119 that receives one or more behavior signals 113 as an input and determines whether or not an organization event 133 is detected, which would trigger the callout affordance 111.

In some examples, organization events 133 may be referred to as clean up events. In some examples, the triggering engine 112 may proactively display the callout affordance 111 in a manner that minimizes interrupting to a user's workflow (e.g., if the user is actively reading or typing, a callout affordance 111 may not be appropriate).

The conditions defining an organization event 133 can include bookmarking/reading list usage on an active browser tab 122. For example, bookmarking is itself an organization task, so if a user is organizing, renaming, editing, etc. bookmarks or reading lists in the browser application 108, this can be a signal of an organization event 133 and an appropriate time to proactively suggest tab organization, e.g., via the callout affordance 111. As another example, the conditions defining an organization event 133 can include dragging tabs within the same tab strip 120, e.g., to reposition tabs bringing one tab closer to another tab, may be considered an organization event 133. If a user is rearranging tabs (via dragging), the user is not actively typing or reading so a proactive tab grouping suggestion may be appropriate. The conditions defining an organization event 133 can include waking the user device 102 (and thus the browser application 108) from an idle (e.g., sleep) state.

The conditions defining an organization event 133 can include resuming the browser application 108 with session restore. A session restore can occur when a browser window 128 (sometimes as a browser window 128 associated with a user account) is opened after the browser application 108 was closed with more than one open browser tab 122. The session restore may not interrupt the user's workflow and may be considered an organization event 133. The conditions defining an organization event 133 can include detecting the user opening duplicate browser tabs 122 that point to the same domain and/or to the same resource locator (URL) but with different parameters. When the user does this but the opened browser tabs 122 do not have focus, this can be considered a signal of an organization event 133. This can occur, for example, if the user is opening links received in an email or other document. These documents may not have any semantic similarity but may be related due to behavior signals 113. The time between the opening of each browser tab 122 can also be considered in the conditions for defining an organization event.

The conditions defining an organization event 133 can include detecting that the user is actively switching between a number of browser tabs 122 that exceed a threshold level within a time window (e.g., a short time-window). For example, a user clicking on several different browser tabs 122 (or hovering over several different browser tabs 122) over a period of time (e.g., a few seconds) may be an indication that the user is searching for information and an organization suggestion is appropriate. The conditions defining an organization event 133 can include filtering factors. Filtering factors are an indication that even if the user behavior indicates a likely organization event 133, these factors cut against proactively suggesting tab groups 116 because the nudging may result in poor clusters or bad timing for the user. The filtering factors may include a minimum number of tabs that are not already organized into a tab group 116. For example, with less than a threshold number of browser tabs being open (e.g., six tabs) (that are not already part of a tab group 116), the clusters may be poor quality. This factor could be overridden by an indication (e.g., a strong indication) of an organization event 133, such as rapid opening of browsing tabs 122 from the same origin document.

The filtering factors can include whether the browser window 128 is an active window (e.g., the user is currently looking at the window and thus, its tab strip 120). The filtering factors can include the recency of interactions with windows/tabs in the browser. For example, if the user is currently clicking through tabs or rearranging tabs, this weighs in favor of an organization event 133. Another filtering factor may be related to the content/topic of a browser tab 122.

In some examples, the filtering factors can include the historical usage of the group suggestions, e.g., how the user has interacted in the past with suggested tab group 116 and/or the callout affordance 111. The historical usage may be collected, with user permission, to personalize when the callout affordance 111 is triggered. Thus, for example, if the user frequently groups tabs for web pages satisfying a particular attribute (e.g., a particular domain, a particular resource locator, a particular category, a particular combination of tabs for different domains/resource locators, etc.), and the current tab strip 120 includes tabs associated with that attribute, this may be a factor for an organization event 133. Likewise, if the user historically does not accept the suggested tab groups 116 or historically actively dismisses the callout affordance 111, this factor weighs against (e.g., heavily against) an organization event 133. Likewise, a user historically accepting a tab group 116 or selecting the callout affordance 111 weighs in favor of an organization event 133.

The triggering engine 112 may detect an organization event 133 based on any combination of the above conditions, including the application of filtering factors. This can be done via heuristics, via a machine learned model that provides a probability for an organization event 133 given the various conditions, or a combination of heuristics and a model, e.g., some conditions may not be used in the model but are used to override the model's output probability, to boost the model's prediction, or to demote the model's probability.

In response to the detection of an organization event 133, the triggering engine 112 may obtain a quality signal 117 associated with one or more tab groups 116. In some examples, the quality signal 117 is a signal that indicates that a quality score associated with the tab group 116 is above a threshold level. In some examples, the quality signal 117 includes the quality score. In some examples, the triggering engine 112 may request the quality signal 117 from a clustering engine 154 before displaying the callout affordance 111. For example, in response to the detection of the organization event 133, the triggering engine 112 may query the clustering engine 154 to determine if the quality (e.g., the quality score 121) of at least one cluster (e.g., tab group 116) is equal to or greater than a threshold level to prompt the user with the callout affordance 111.

In some examples, the tab organizer 152 may have pre-generated suggested tab groupings (e.g., before an organization event 133 is detected), so querying the clustering engine 154 may be obtaining these pre-generated suggested tab groups. This pre-generation of suggested clusters (suggested tab groups 116) may be done when the tab strip 120 is stable (e.g., no new tabs have been added or closed within a given timeframe, e.g., one minute, five minutes, ten minutes, etc.). If a new browser tab 122 is opened or a browser tab 122 is closed, any pre-suggested clusters may be deleted (or membership adjusted, if a browser tab 122 is closed). The cluster quality can be represented as a quality score. The quality score 121 can be based on the number of members in a cluster. The quality score 121 can be based on the confidence score for a label 118 generated for the cluster. For example, if a top scoring generated label 118 has a confidence score that does not meet a threshold, this can be a signal that the browser tabs 122 in the cluster are not similar. The quality score 121 can be based on a confidence score generated for the cluster. The quality score 121 can be based on a category/type for the cluster, e.g., determined by the content of the web pages associated with the browser tabs 122 contained within a cluster. The quality score 121 of a cluster can thus be a combination of a variety of factors. In some examples, if an organization event 133 is detected, and if at least one cluster meets a quality threshold (e.g., the quality score 121 of that cluster satisfies the quality threshold), the triggering engine 112 may display the callout affordance 111 in the tab strip 120.

In response to the user selection of the organize control 123 (or, more generally, a user selection on the callout affordance 111), the tab manager 110 may initiate (e.g., invoke, execute, activate, etc.) the tab organizer 152, which causes a display of a tab group interface 124, as shown in FIG. 1B. The tab group interface 124 may identify one or more tab groups 116 as suggestions to the user. For example, the tab group interface 124 identifies a tab group 116 with two or more semantically related browser tabs 122 such as browser tab 122-2 and browser tab 122-3. The tab browser tabs 122 selected for inclusion within a tab group 116 may be determined based on an analysis of the web pages rendered in the browser tabs 122 in the browser window 128 and/or other browser windows 128 opened on a user device 102. Referring to FIG. 1D, the tab organizer 152 is configured to perform a clustering operation on the plurality of browser tabs 122 to identify semantically related browser tabs 122 based on tab information 114 about the plurality of browser tabs 122.

As shown in FIG. 1B, the tab group interface 124 identifies a label 118 generated by a labeling engine 156. In some examples, the label 118 is a machine-generated label. The label 118 may include a short description of the tab group 116, and, in some examples, an icon that represents the content of the tab group 116. The tab group interface 124 is a tabbed interface. The tab group interface 124 includes an all tab section 124a and an organizer tab section 124b. The all tab section 124a may identify all browser tabs 122 opened on the user device 102. The organizer tab section 124b may identify one or more tab groups 116 as tab group suggestions. In some examples, the tab group interface 124 includes an editable field 125 that includes the label 118, which allows the user to edit the machine-generated label 118. The tab group interface 124 includes a create control 126 for creating the tab group 116. In response to user selection of the create control 126.

As shown in FIG. 1C, the tab manager 110 may modify the tab strip 120 to include the label 118 and the tab group 116 with the semantically related browser tabs 122. For example, the tab manager 110 may insert the label 118 into the tab strip 120. The tab manager 110 may place related tabs 122, corresponding to the label 118, after the label 118. In some examples, the tab manager 110 may identify the tab group 116 in the tab strip 120 proximate to (e.g., next to, adjacent to, or directly adjacent to) the label 118, wherein a selection of the label 118 causes the tab group 116 to collapse to a collapsed state or expand to an expanded state. In other words, the label 118 can be part of an affordance that can be toggled, e.g., collapsing the browser tabs 122 in the tab group 116 when selected a first time and expanding the browser tabs 122 in the tab group 116 when selected a second time, etc. In the collapsed state, the label 118 is displayed, but the individual browser tabs 122 of the tab group 116 in the tab strip 120 are hidden (e.g., not visible to the user). In the expanded state, the label 118 and the browser tabs 122 of the tab group 116 are displayed.

Referring to FIG. 1D, the tab manager 110 generates tab information 114 about the browser tabs 122 opened on the user device 102. In some examples, the tab manager 110 generates the tab information 114 when the tab organizer 152 is invoked by the tab manager 110. In some examples, as shown in FIG. 1E, the tab information 114 may include page titles 170 of the webpages included in the browser tabs 122 opened on the user device 102. In some examples, the tab information 114 includes resource locators 172 of the webpages included in the browser tabs 122 opened on the user device 102. In some examples, the resource locators 172 include uniform resource locators (URL) of the webpages included in the browser tabs 122 opened on the user device 102. In some examples, the tab information 114 includes page content 174 of the webpages included in the browser tabs 122 opened on the user device 102. In some examples, the tab information 114 includes one or more behavior signals 113 associated with a user's browsing history.

The tab manager 110 may transmit the tab information 114 to the tab organizer 152. The tab organizer 152 includes a clustering engine 154 configured to identify one or more tab groups 116 from the plurality of browser tabs 122 based on the tab information 114. In some examples, the clustering engine 154 uses a combination of two or more of the page titles 170, the resource locators 172, the page content 174, and the behavior signal(s) 113. In some examples, the clustering engine 154 may identify one or more tab groups 116 using the page titles 170 and the resource locators 172. In some examples, the clustering engine 154 may identify one or more tab groups 116 using the pages titles 170, the resource locators 172, and the page content 174. In some examples, the clustering engine 154 may identify one or more tab groups 116 using the pages titles 170, the resource locators 172, the page content 174, and the behavior signals 113.

In some examples, the clustering engine 154 clusters the browser tabs 122 into one or more subsets using similarities. In some examples, the clustering engine 154 clusters the browser tabs 122 into one or more subsets using one or more machine-learning (ML) models.

The clustering engine 154 may include an embedding model 158 configured to generate embeddings 130 about the web pages using the tab information 114. The clustering engine 154 may compute similarity scores 132 based on the embeddings 130, and cluster a subset 122a of the open browser tabs 122 based on the similarity scores 132. The subset 122a includes the semantically related browser tabs of a respective tab group 116.

In some examples, the clustering engine 154 computes semantic similarity between tabs 122 based on their page titles 170 and the resource locators 172. In some examples, the clustering engine 154 computes raw pairwise embedding similarity, and then further computes a Jaccard similarity between tabs based on their neighbors with embedding similarities achieving a certain threshold (e.g., equal to or above a certain threshold). In some examples, the clustering engine 154 uses the embedding model 158 to represent a given set of tabs 122 as embeddings 130 based on the page titles 170 and the resource locators 172. The clustering engine 154 may compute their pairwise dot-product similarity scores. The clustering engine 154 may obtain the neighbors of tabs 122 with raw embedding similarities above a given threshold, and compute Jaccard similarity. The Jaccard similarity may measure the overall similarity between tabs 122 based on how many common neighbors they share. Compared to the pairwise embedding similarity, the Jaccard similarity may be more robust against noises due to the embedding model 158.

With the Jaccard tab similarities, the clustering engine 154 may execute a clustering algorithm over the input tabs 122 to generate clusters as tab groups 116. In some examples, the initial clustering algorithm can generate large clusters that may have lower quality, e.g., clusters contain unrelated tabs. In some examples, the clustering engine 154 may measure the intra-cluster variance of tab similarities, and, when the variance achieves a threshold (e.g., is equal to or above a threshold), the clustering engine 154 may perform post-processing by further clustering the tabs within the original clusters.

In some examples, the clustering engine 154 may cluster the tabs 122 into subsets 122a based on semantic signals 169 and/or behavior signals 113. Semantic signals 169 represent the content of the web page (e.g., page content, titles, URLs, main entity extraction, etc.). Semantic signals 169 measure the content similarity between two tabs, e.g., representing tabs using embedding vectors calculated by a machine-learning (ML) model (e.g., the embedding model 158) that projects the content in a vector space where similar contents are placed close to each other. A similarity score between two tabs can then be computed as the dot-product between embedding vectors for the tabs 122.

Behavior signals 113 represent attributes about the tab 122 within the browser context. These attributes can be based on user behavior in interacting with the tabs 122, attributes of the tab 122, and/or attributes of the web pages represented by the tab 122. Behavior signals 113 can include navigation chains (e.g., a signal indicating that two tabs are in the same navigation chain). In a navigation chain, two tabs may be in the same chain because a first tab was opened from a link in a second tab. However, as the web page associated with the first tab changes, the link between the two tabs weakens. If a non-related web page is opened in the first tab or the second tab (e.g., the user types in a resource locator in the address bar/omnibox, this can be interpreted in the signals as a weak link or may break the navigation chain altogether, so the two tabs are no longer considered to be in the same navigation chain.

Behavior signals 113 can include link clicks, e.g., where one tab is created by clicking a link in the other tab. Behavior signals 113 can include recency (time) signals. Recency signals can include a gap between the last active times of the two tabs, a gap between the tab creation times of the two tabs, and/or whether a tab is created while the other tab is active. Behavior signals 113 can include tab location, or adjacency. For example, distance between the two tabs (based on locations in the tab strip) can be used, where tabs closer in location to each other may be considered more similar.

Behavior signals 113 can include historical tab grouping and browsing signals, e.g., an estimated probability of tab usage relative to the other tab. For example, if a user has historically opened tabs or grouped tabs in the same vertical/category/domain together, tabs matching that vertical/category/domain pairing may have a higher similarity. Any attributes about the web site represented by tabs historically grouped or opened together can be used in an embedding to determine whether tabs (e.g., the web pages associated with the tabs) in the current tab strip should be grouped together. Behavior signals 113 can include bookmarking signals, e.g., where tabs are similar when they are both in the same bookmark sub-folder. Behavior signals 113 can include a domain, where two tabs are similar when they are in the same domain.

In some implementations, the clustering engine 154 may execute a first clustering algorithm to generate tab groups 116 using semantic signals 169 and may execute a second clustering algorithm to generate tab groups 116 using behavior signals 113. The cluster quality can determine which of these clusters are selected. In some examples, a clustering algorithm may use both types of signals. The clustering engine 154 may define the set of signals between a pair of tabs. The signals, semantic or behavior-related, can be used to compute a similarity/linkage score between two tabs, e.g., via a machine learning model. The system may then cluster the groups (e.g., via clustering algorithms) based on the tab similarity scores.

For example, given a representation of each tab requested to be clustered, the clustering engine 154 may compute the pairwise similarity scores for all pairs of tabs. With the similarity scores, the clustering engine 154 may use an unsupervised clustering algorithm to assign each tab to at most one group, i.e., so that each suggested group includes a subset of tabs. Implementations can leverage various clustering algorithms, such as Affinity Propagation, DBSCAN, Agglomerative Clustering, among others. Typically, the clustering process involves iteratively merging tabs into groups/clusters. In some examples, the clustering engine 154 may provide the ability to generate clusters that shuffle the prioritization, or weights, of the clustering algorithm between the two signal types (semantic and behavioral). This may allow for clusters to be generated with different structures-some based mostly on semantic signals, and some based on behavior signals. This would enable the UI (e.g., tab group interface) to allow the user to request re-clustering or variations of the clustering that best fits their tab group preferences.

In some implementations, the system may use a generative model, such as a language model to generate clusters. In some implementations, the language model may be a large language model. For example, the tabs and signals may be provided to a language model with the prompt to group (or cluster) the tabs. In some implementations, the language model could be prompted to recommend clusters on behavior signals or on semantic signals, or to weight behavior signals more than semantic signals, weight them equally, or to weigh semantic signals more than behavior signals. In some implementations, the language model may provide the proposed groups in a JSON format.

The tab organizer 152 includes a labeling engine 156 configured to generate a label 118 for a respective tab group 116 using at least a portion of the tab information 114. In some examples, the labeling engine 156 uses only the page titles 170 and the resource locators 172 of a respective tab group 116 to generate the label 118. In some examples, the labeling engine 156 may generate the label 118 using the page titles 170, the resource locators 172, and the page content 174.

The label 118 may include a short description of the subject of the semantically related browser tabs 122 of a respective tab group 116. In some examples, the label 118 is four words or less. In some examples, the label 118 is three words or less. In some examples, the label 118 includes an icon that represents the subject matter of the semantically related browser tabs 122 of a respective tab group 116. In some examples, the icon includes an emoji. In some examples, the labeling engine 156 may generate concise descriptive label 118 for each tab group 116, which may be one or two words, and, in some examples, include an emoji.

The labeling engine 156 may include a generative model 164. In some examples, the tab organizer 152 may generate a prompt for the generative model 164, where the prompt includes at least a portion of the tab information 114. In some examples, the prompt includes the page titles 170 and the resource locators 172 of a respective tab group 116. The generative model 164 may use the tab information 114 (or a portion thereof) as an input to the language model 164 and generate a model response as an output, where the model response includes the label 118. In some examples, the generative model 164 uses the page titles 170 and the resource locators 172 as inputs.

In some examples, the generative model 164 is a predefined language model (e.g., an LLM) that has been trained on publicly available data. In some examples, the generative model 164 is a multi-modality model, which can receive images and text. In some examples, the generative model 164 is a specifically trained language model that has been specifically configured to generate a label 118 using at least a portion of the tab information 114. The tab manager 110 may receive the group(s) 116 and the label(s) 118 from the tab organizer 152 and include the group(s) 116 and the label(s) 118 in the tab group interface 124.

In some examples, the generative model 164 may be a pre-trained language model configured with in-context learning. In-context learning is a natural language processing (NPL) technique that includes conditioning a pre-trained language model on a specific domain by providing the pre-trained model with additional data (e.g., a portion of the tab information 114, including the page titles 170 and the resource locators 172) that is specific to that domain. The generative model 164 may include one or more neural networks, and the neural network(s) may be already pre-trained with a relatively large amount of training data to generate weights associated with the neural network(s). In some examples, the generative model 164 uses in-context learning to condition (e.g., fine-tune, calibrate, adjust) the already pre-trained generative model to generate labels 118 using the page titles 170 and the resource locators 172 as inputs. In some examples, conditioning the generative model 164 does not involve adjusting one or more of the weights of the generative model 164.

In some examples, the generative model 164 is configured to receive a list of page titles 170 and their resource locators 172, group similar pages together, and propose a label 118 and potentially an emoji for them in its output. In some examples, the model response 136 is in a JSON format. Since fewer output tokens lead to faster response generation, the model response 136 may include page indices instead of page titles 170 and/or resource locators 172.

The label generation may use a generative model 164 that takes several signals about the tabs within the group as input in order to generate the labels. The signals about the tabs can include content signals, such as tab domain and URL, tab page title, tab page content, an indication of whether or not the tab content includes form fields, a count of images on the web page, and/or an indication of whether the cluster was created primarily on content signals. The behavior signals may include an indication of whether the tab group was created primarily based on behavior signals.

In some implementations, and with user consent, the signals may include user history signals, e.g., whether this user has selected an emoji as the label more often than words or whether the user has selected more generalized suggestions (e.g., travel) over more specialized suggestions (e.g., hotels). These historical signals can be stored, with user permission, in local user profile data. The generative model 164 may output a structure label that will ensure it fits within the tab Group UI (e.g., is one or two words, less than four words, etc.). The generative model 164, based on the potential input contexts may also provide an emoji as part of the label or as a separate label. The generative model 164 may be fine-tuned (specially trained) to meet the required output structure. In some implementations, a single call to the generative model 164 may generate several candidate labels for the cluster. These suggested labels may be provided in an ordered list, as discussed herein.

Further to the descriptions above, a user may be provided with controls allowing the user to make an election as to both if and when systems, programs, or features described herein may enable collection of user information (e.g., information about a user's historical usage of the browser, a user's preferences, or a user's current location), and if the features described herein are active. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

FIG. 1F illustrates a flow diagram depicting example operations of the tab manager 110 and the tab organizer 152 according to an aspect. In operation 171, the tab manager 110 may detect an organization event 133 based on behavior signal(s) 113, and, in response to the detection of the organization event 133 may trigger a callout affordance 111. In response to a user interaction with the callout affordance 111 (e.g., the user has selected the organize control 123), the tab manager 110 may activate the tab organizer 152 to identify a tab group 116 and generate a label 118 for the tab group 116. The tab manager 110 may generate the tab information 114. In operation 173, the tab organizer 152 may perform tab pre-filtering on the tab information 114. In some examples, the tab pre-filtering includes applying a security filter to remove sensitive tabs.

In operation 175, the clustering engine 154 may initiate an embedding inference using the tab information 114. For example, the embedding model 158 may execute an interference operation using the tab information 114 as an input, which generates embeddings 130. In operation 177, the clustering engine 154 may compute similarity scores 132 based on the embeddings 130, and cluster a subset 122a of the open browser tabs 122 based on the similarity scores 132. The subset 122a includes the semantically related browser tabs of a respective tab group 116.

The tab manager 110 may transmit a set of tabs (e.g., identified by tab identifiers), including page titles 170 and resource locators 172, to the tab organizer 152 for clustering. In some examples, the clustering engine 154 may generate embeddings 130 for the tabs 122 by sending inference requests to the embedding model 158. The clustering engine 154 may compute the pairwise similarity scores (e.g., the similarity scores 132) based on the embeddings 130. The clustering engine 154 may execute a clustering algorithm to generate tab groups 116 (e.g., also referred to as clusters or tab clusters). The tab groups 116 may be sent for labeling if a tab group 116 has a quality score 121 that achieves a quality threshold (e.g., equal to or above a threshold amount). The tab groups 116 (e.g., up to the maximum number of allowed clusters) may be transmitted to the tab manager 110. In some examples, the clustering engine 154 may order the tab groups 116 by one or more scores (e.g., quality and importance of clusters).

In operation 179, the tab organizer 152 may initiate the generation of a label 118 for a respective tab group 116 using at least a portion of the tab information 114. In some examples, the tab organizer 152 includes a generative model 164 that receives a prompt 134 with at least a portion of the tab information 114 and generates a model response 136 with the label 118. In some examples, the generative model 164 generates a plurality of labels 118 for a respective tab group 116. In operation 181, the tab organizer 152 may perform label and cluster post-filtering. In operation 183, in some examples, the tab organizer 152 may rank the plurality of labels 118 according to one or more ranking signals and may select a label 118 with the highest rank as the label for a respective tab group 116. In operation 185, the tab manager 110 may receive the tab group(s) 116 and the label(s) 118 from the tab organizer 152.

In some examples, the tab organizer 152 may transmit each tab group 116 in a prompt 134 to a generative model 164 and receives the model response 136. In some examples, the label 118 includes a JSON format for description and emoji field. In some examples, the tab organizer 152 may use the model response 136 and parse it into a JSON object. In some examples, the tab organizer 152 may determine one or more quality checks (e.g., whether a label 118 has a description length that is less than a threshold level (e.g., less than three words). If one or more quality checks fail, the tab organizer 152 may modify the prompt 134 and request the generative model 164 to regenerate a label 118. If the quality checks pass, the tab organizer 152 may assign the generated label 118 to a corresponding tab group 116.

The user device 102 may be any type of computing device that includes one or more processors 101, one or more memory devices 103, a display 138, and an operating system 105 configured to execute (or assist with executing) one or more applications 106, including the browser application 108. In some examples, a browser application 108 is a web browser configured to access information on the Internet. The browser application 108 may launch one or more browser tabs 122 in the context of one or more browser windows 128 on a display 138 of the user device 102. A browser tab 122 may display content (e.g., web content) associated with a web document (e.g., webpage, PDF, image, video, or generally any item identifiable by a resource locator 172, etc.) and/or an application such as a web application, progressive web application (PWA), and/or extension. A web application may be an application program that is stored on a remote server (e.g., a web server) and delivered over the network 150 through the browser application 108 (e.g., a browser tab 122). In some examples, a progressive web application is similar to a web application but can also be stored (at least in part) on the user device 102 and used offline. An extension adds a feature or function to the browser application 108. In some examples, an extension may be HTML, CSS, and/or JavaScript based (for browser-based extensions).

In some examples, the user device 102 is a laptop computer. In some examples, the user device 102 is a desktop computer. In some examples, the user device 102 is a tablet computer. In some examples, the user device 102 is a smartphone. In some examples, the user device 102 is a wearable device. In some examples, the display 138 is the display of the user device 102. In some examples, the display 138 may also include one or more external monitors that are connected to the user device 102.

The processor(s) 101 may be formed in a substrate configured to execute one or more machine executable instructions or pieces of software, firmware, or a combination thereof. The processor(s) 101 can be semiconductor-based—that is, the processors can include semiconductor material that can perform digital logic. The memory device(s) 103 may include a main memory that stores information in a format that can be read and/or executed by the processor(s) 101. The memory device(s) 103 may store the browser application 108, the tab manager 110 (and, in some examples, one or more aspects of the tab organizer 152) that, when executed by the processors 101, perform certain operations discussed herein. In some examples, the memory device(s) 103 includes a non-transitory computer-readable medium that includes executable instructions that cause at least one processor (e.g., the processors 101) to execute operations.

The server computer(s) 160 may be computing devices that take the form of a number of different devices, for example a standard server, a group of such servers, or a rack server system. In some examples, the server computer(s) 160 may be a single system sharing components such as processors and memories. In some examples, the server computer(s) 160 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computers, servers, routers, network switches, etc.) that are configured to receive and/or transmit data within network 150. Network 150 may further include any number of hardwired and/or wireless connections.

The server computer(s) 160 may include one or more processors 161 formed in a substrate, an operating system (not shown) and one or more memory devices 163. The memory device(s) 163 may represent any kind of (or multiple kinds of) memory (e.g., RAM, flash, cache, disk, tape, etc.). In some examples (not shown), the memory devices may include external storage, e.g., memory physically remote from but accessible by the server computer(s) 160. The processor(s) 161 may be formed in a substrate configured to execute one or more machine executable instructions or pieces of software, firmware, or a combination thereof. The processor(s) 161 can be semiconductor-based—that is, the processors can include semiconductor material that can perform digital logic. The memory device(s) 163 may store information in a format that can be read and/or executed by the processor(s) 161. In some examples, the memory device(s) 163 may store the one or more aspects of the tab organizer 152 (e.g., the clustering engine 154, the labeling engine 156) that, when executed by the processor(s) 161, perform certain operations discussed herein. In some examples, the memory device(s) 163 includes a non-transitory computer-readable medium that includes executable instructions that cause at least one processor (e.g., the processor(s) 161) to execute operations.

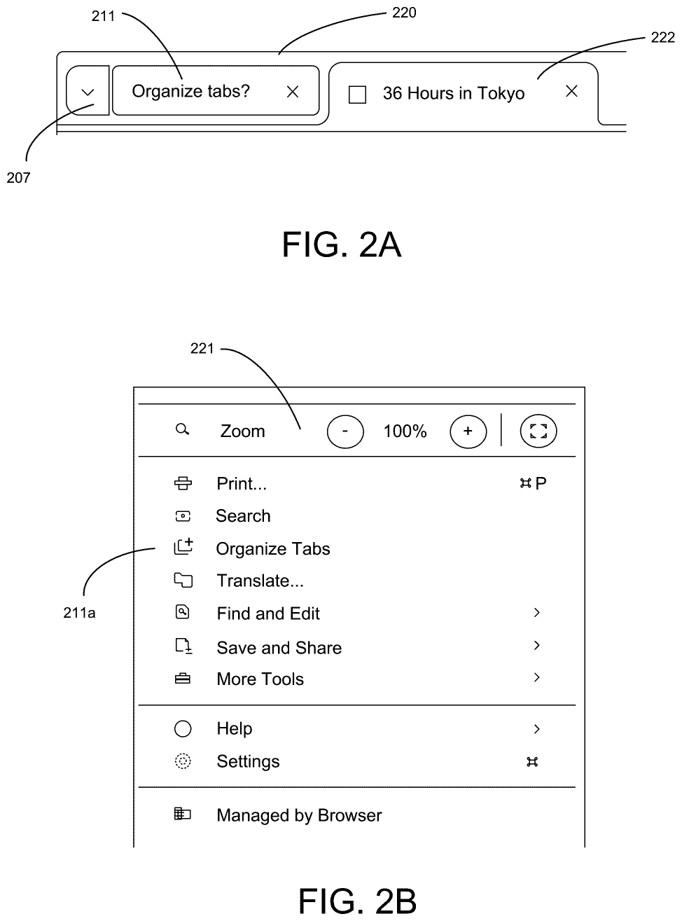

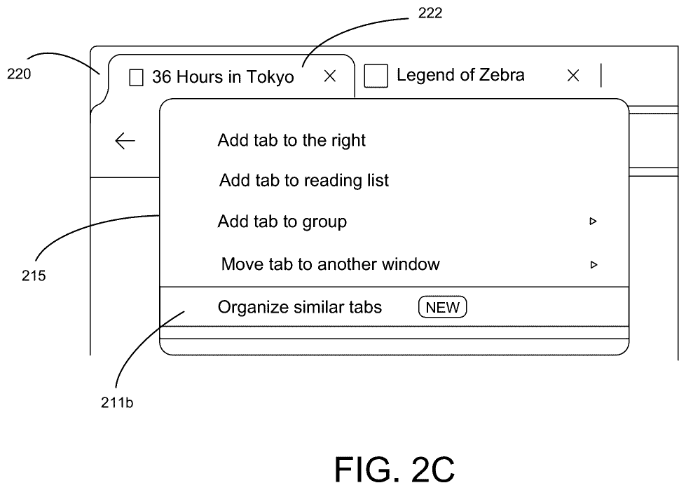

FIG. 2A illustrates a portion of an example tab strip 220 with a callout affordance 211 (e.g., a proactive callout affordance) for enabling the user to initiate a tab organizer (e.g., the tab organizer 152 of FIGS. 1A to IF). In some examples, the callout affordance 211 is referred to as a tab organize button.

The callout affordance 211 may be a selectable element in the tab strip 220, which, when selected, causes the tab organizer to be initiated. In some examples, in response to selection of the callout affordance 211, the callout affordance 211 may expand and display a loading indicator. A triggering engine (e.g., the triggering engine 112 of FIGS. 1A to 1G) may selectively display the callout affordance 211 in the tab strip 220 according to any of the techniques described with respect to FIGS. 1A to 1G.

The portion of the tab strip 220 shows one tab 222, but the tab strip 220 may include other tabs (not shown). As shown in FIG. 1A, the callout affordance 211 may be positioned adjacent to (e.g., directly adjacent to) a tab search button 207. If tab search button 207 is not included in the tab strip 220, the callout affordance 211 may be positioned at either end of the browser tabs 222 in the tab strip 220. For example, the callout affordance 211 of FIG. 2A is illustrated at a left end of the browser tabs 122, but the callout affordance 211 may be displayed at a right end of the browser tabs 122 in the tab strip 220. In some examples, the triggering engine may animate the callout affordance 211 or the tab strip 220 (or a portion thereof) when the callout affordance 211 is triggered to be displayed. In other words, providing the callout affordance 211 may include an animation that moves the location of the existing browser tabs 122 to create space in the tab strip 220 for the callout affordance 211.

The primary entry point to the feature (e.g., the tab organizer) may be the callout affordance 211, which may be a visual extension to the tab search button 207. In some examples, the tab search button 207 may extend a tab strip control button, which is a UI element that is a child of a tab strip region view. With the addition of the callout affordance 211, the browser application 108 may create a new tab search container view, which has the tab search button 207 and the callout affordance 211 as children UI elements of the tab search container view. In some examples, tab strip region view may replace its tab search button child and all references to its layout with tab search container. The tab strip control button may gain an animation (e.g., a graphics file format (gfx) animation) to animate the rounding and/or flattening of its corners. The tab organize button (e.g., similar to the tab search button 207) may extend the tab strip control button and have an animation to animate its width.

As explained with reference to FIGS. 1A to 1G, in response to the detection of an organization event (e.g., the organization event 133 of FIGS. 1A to 1G), the triggering engine may display the callout affordance 211 (e.g., transition from hide to show). In some examples, the tab search container may expose a set expanded (bool expanded) method that callers may use to trigger the callout affordance 211. When invoked, a tab search container may manage the animation sequencing between the two buttons (e.g., the tab search button 207, the callout affordance 211) and may set the edge of each button, if any, to have sharp corners (e.g., shaper corners). In some examples, the tab search container may maintain its current expanded/collapsed state while the user is hovering over the tab strip 220. In some examples, a tab search container may store two additional variables, e.g., a first variable (e.g., should_change_state) and a second variable (e.g., state_changes_allowed). The tab strip region view may listen to tab strip mouse events and set tab search container with the second variable on mouse enter/exit. In some examples, tab search container's set expanded calls may set the tab search container with the first variable (e.g., should_change_state) without animating if the second variable (e.g., state_changes_allowed) is false. When the second variable (e.g., state_changes_allowed) changes from false to true, the tab search container may invoke set expanded if the first variable (e.g., should_change_state) is truc.

FIG. 2B illustrates an example of a browser menu 221 with a callout affordance 211a for enabling the user to initiate a tab organizer (e.g., the tab organizer 152 of FIGS. 1A to 1G). In some examples, the callout affordance 211a of FIG. 2B may be disabled (grayed out and not selectable) if a group is unlikely to be created (e.g., a quality score 121 not achieving a quality threshold (e.g., being less than a threshold level)). Some of the conditions and factors used to determine whether an organization event (e.g., the organization event 133) has occurred may also be used to determine whether a group is likely to be created or not.

FIG. 2C illustrates a portion of an example tab strip 220 with a callout affordance 211b for enabling the user to initiate a tab organizer (e.g., the tab organizer 152 of FIGS. 1A to 1G). The portion of the tab strip 220 shows one browser tab 222, but the tab strip 220 may include other tabs (not shown). The callout affordance 211b of FIG. 2C appears in a tab context menu 215. The tab context menu 215 may be displayed in response to a user right-clicking on the tab 222. In some implementations, the callout affordance 211b may be disabled and grayed out if a tab group is unlikely to be created (e.g., a quality score 121 not achieving a quality threshold (e.g., being less than or equal to a threshold level)), as explained with respect to FIG. 2B. The callout affordance 211b may trigger organization specific to the browser tab 222, rather than a general organization pass across the tab strip 220 or across multiple tab strips 220 (e.g., in the case of multiple browser windows). Thus, for example, any suggested clusters should include the tab 122. Thus, for example, if clusters have been pre-determined before the user triggers the tab context menu 215 and the current browser tab 222 is not in one of the suggested clusters (or is in a suggested cluster with a low quality score), the callout affordance 211b may be grayed out and disabled.

The tab organization service (e.g., the tab organization service 145 of FIGS. 1A to 1G) can be disabled or enabled by the user. For example, a settings UI of the browser application may include an affordance to disable showing the callout affordance. If the callout affordance is disabled, the callout affordance 211 of FIG. 2A is not displayed. If the callout affordance is disabled, the callout affordance 211a of FIG. 2B or the callout affordance 211b of FIG. 2C is not activated (e.g., grayed out and disabled).

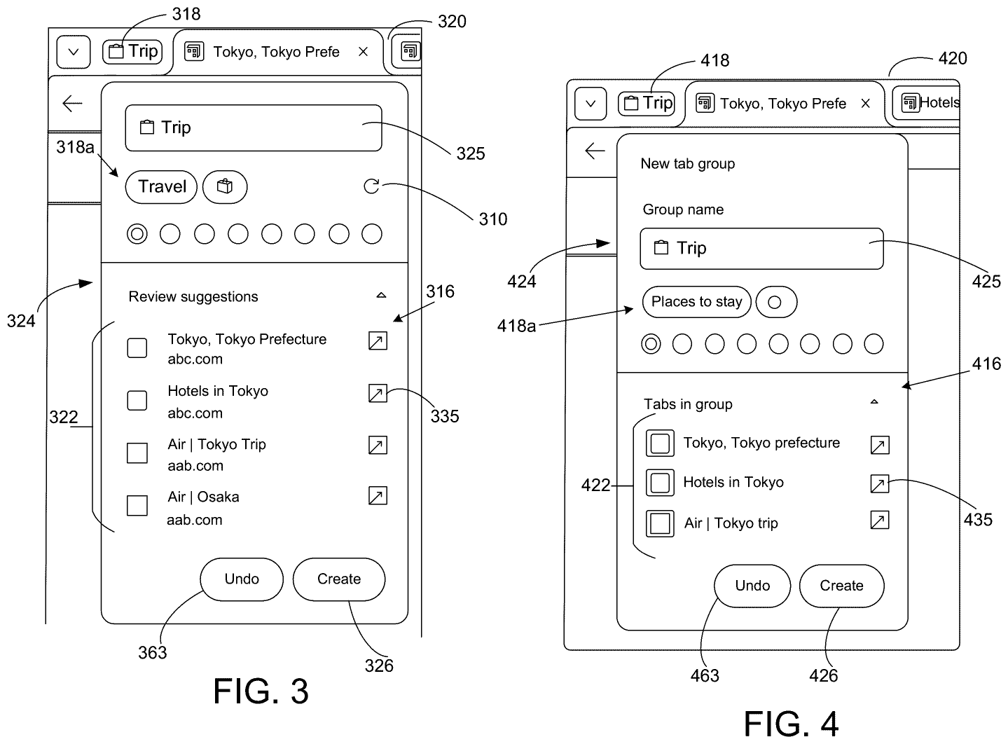

FIG. 3 illustrates an example of a tab group interface 324 according to an aspect. The tab group interface 324 may be an example of the tab group interface 124 of FIGS. 1A to 1G and may include any of the details discussed herein. The tab group interface 324 may be generated and displayed in response to the user initiating a tab organization action, e.g., in response to selection of a callout affordance, e.g., the callout affordance 111 of FIGS. 1A to 1G, and the callout affordances 211, 211a, and/or 211b of FIGS. 2A through 2C. In some examples, a tab organizer (e.g., the tab organizer 152 of FIGS. 1A to 1G) may select a grouping with a highest quality score (e.g., a quality score 121 of FIG. 1E) and generate a tab group 316. In some examples, a tab strip 320 includes a label 318 of the tab group 316 identified in the tab group interface 324. In some examples, the label 318 may include the selected label for the tab group 316, e.g., from a label field 325. In some examples, a tab group 316 is not created until the user actually selects a create control 326.

While similar to a tab group editor interface (e.g., an interface generated in response to a tab group edit action that allows a user to relabel an existing tab group, add a tab to an existing tab group, etc.), the tab group interface 324 may include additional fields (elements) not included in a tab group editing interface. For example, the tab group interface 324 may include an undue control 363. The undue control 363 may be configured to undo the tab grouping, e.g., to delete the grouping and restore the previous tab strip indices of each of the grouped tabs 322. The restoration of the previous tab strip indices can be handled in the same manner as closing an existing tab group. In implementations where the highest-quality tab grouping is not automatically made, the undue control 363 may close the tab group interface 324 without taking any further action.

The tab group interface 324 may also include a remove control 335. Each of the tabs 322 in the tab group 316 may have a corresponding remove control 335. The remove control 335 may be configured to remove the tab it corresponds to from the tab group. Like undo, this may restore the previous tab strip location of the removed tab as relative to other tabs, while maintaining the rest of the tab group. This may require calculation of the new expected tab strip index, as the old index will be out of date with the addition of the group.

The tab group interface 324 may include label field 325. The label field 325 may be populated with the label 318 selected by a labeling engine (e.g., the labeling engine 156 of FIGS. 1A to 1G). In some examples, the label field 325 is editable. In other words, the user can modify or replace the label 318 of the tab group 316 by typing into the label field 325. The tab group interface 324 can also include one or more suggested labels 318a (e.g., one or more alternative terms and/or one or more alternative icons), which are generated by the labeling engine. The suggested labels 318a may be supplied in a prioritized list. The prioritized list may be ordered by confidence scores for the labels 318. The system may use a highest-ranked (highest-confidence) label 318 to auto-populate the label field 325. The other suggested labels may be provided as suggested labels 318. The suggested labels 318a may be selectable UI elements, where selection of one of the suggested labels 318a may change the label 318 in the tab strip 320 and the label 318 in the label field 325.

The tab group interface 324 may include a refresh control 310. In some examples, in response to user selection of the refresh control 310, a tab organization service (e.g., the tab organization service 145 of FIGS. 1A to 1G) may provide new suggested labels 318a. In some examples, in response to selection of the refresh control 310, the tab organization service may generate and/or provide a list of potential labels 318 (e.g., a prioritized list of potential labels 318) (e.g., approximately 4-6, 8-10, 10-15, etc.). In some examples, the suggested labels 318a may be cached (e.g., in the prioritized list), so the refresh of the suggested labels 318a may be nearly instantaneous. Repeated selection of the refresh control 310 may cycle through the list, looping back to the beginning with sufficient refresh calls. In some examples, the tab organization service may provide a short, prioritized list of a certain number of labels 318 (e.g., five labels, four labels, three labels, two labels, etc.) at a time, and these may all be displayed, e.g., in the label field 325 and as suggested labels 318a. Some implementations may display more than two suggested label controls. In such an implementation, selection to the refresh control 310 may not be instantaneous as it may require a server call, unless the models are on-device. Such a refresh may come up with arbitrarily many potential labels 318.

FIG. 4 illustrates an example of a tab group interface 424 according to another aspect. The tab group interface 424 may be an example of the tab group interface 124 of FIGS. 1A to 1G and/or the tab group interface 324 of FIG. 3 and may include any of the details discussed with reference to those figures. Tab group interface 424 of FIG. 4 could be an example of new suggested labels 418a for the tab group of FIG. 3. The tab group interface 424 includes a label 418 in a tab strip 420, a label field 425, an undue control 463, and a create control 426. FIG. 4 also illustrates a different presentation of the tabs 422 in a tab group 416. For example, the tab group interface 424 may include, for each tab 422 identified in the tab group 416, a favicon, a web page title and a shortened locator. Tab group interface 424 includes, for each tab in the auto-grouped tabs 422, the web page title and favicon (e.g., only the web page title and favicon). The tab group interface 424 may also include a remove control 435. Each of the tabs 422 in the tab group 416 may have a corresponding remove control 435. The remove control 435 may be configured to remove the tab it corresponds to from the tab group. Other information about the web pages represented by the grouped tabs 422 could be used in the tab group interface 124 of FIGS. 1A to 1G, the tab group interface 324 of FIG. 3, and/or the tab group interface 424 of FIG. 4.

In some examples, the tab group interface 124 of FIGS. 1A to 1G, the tab group interface 324 of FIG. 3, and/or the tab group interface 424 of FIG. 4 may be dismissed (e.g., removed from the browser user interface) in response to selection of the undue control (e.g., the undue control 363 of FIG. 3 or the undue control 463 of FIG. 4). In some examples, a tab group interface does not include an undue control. In some examples, where the suggested tab group has been created, selection of a create control (e.g., the create control 126 of FIGS. 1A to 1G, the create control 326 of FIG. 3 and/or the create control 426 of FIG. 4 may result in removal of the tab group interface. In implementations where the suggested tab group 316 has not yet been created, selection of the create control may generate the group and change the appearance of the tab strip accordingly, before closing the tab group interface.

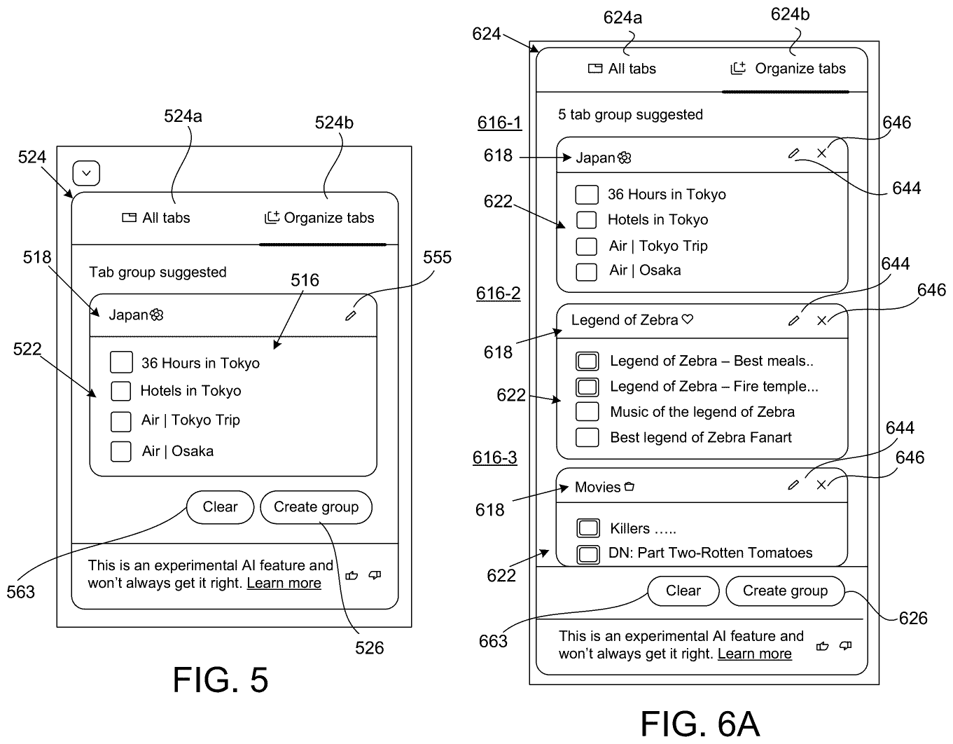

FIG. 5 illustrates an example of a tab group interface 524 according to another aspect. In some examples, the tab group interface 524 suggests a single tab group 516 with two or more semantically related browser tabs 522. The tab group interface 524 may be a tabbed interface. The tab group interface 524 includes an all tab section 524a and an organizer tab section 524b. The all tab section 524a may identify all browser tabs 522 opened on a user device. The organizer tab section 524b may identify the tab group 516 as a tab group suggestion.

In response to the user selection of a callout affordance, a tab manager (e.g., the tab manager 110 of FIGS. 1A to 1G) may initiate (e.g., invoke, execute, activate, etc.) a tab organizer (e.g., the tab organizer 152), which causes a display of the tab group interface 524. The tab group interface 524 may identify a tab group 116 as a suggestion to the user, where the tab group 116 includes related browser tabs 522. As shown in FIG. 5, the tab group interface 524 identifies a label 118 generated by a ML model (e.g., the generative model 164 of FIGS. 1A to 1G). The label 118 may include a short description of the tab group 516, and, in some examples, an icon that represents the content of the tab group 516.

The tab group interface 524 may include an edit control 555. The edit control 555, when selected, is configured to enable the user to edit the label 518. In some examples, the edit control 555, when selected, is configured to render an input field to modify the description and/or icon of the label 518. The tab group interface 524 includes a create control 526 for creating the tab group 516 in a tab strip. The create control 526, when selected, is configured to modify the tab strip to include the tab group 516. The tab group interface 524 includes a clear control 563. The clear control 563 may be configured to undo the tab grouping, e.g., to delete the grouping and restore the previous tab strip indices of the grouped tabs 522.

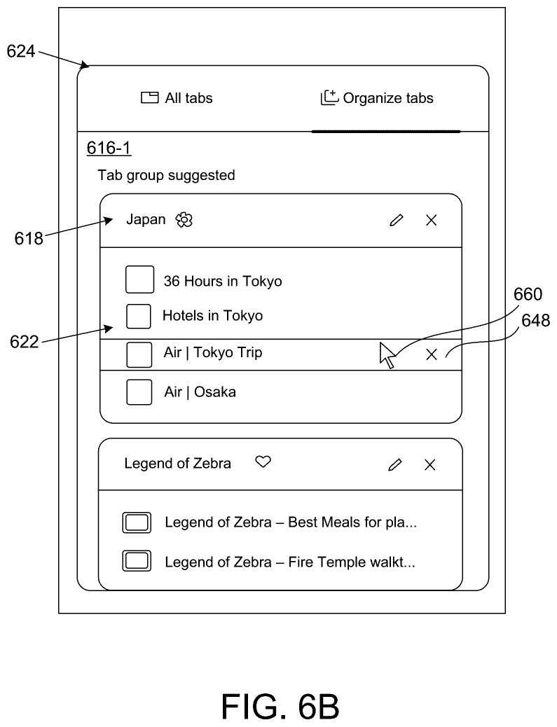

FIGS. 6A and 6B illustrate an example of a tab group interface 624 according to another aspect. In some examples, the tab group interface 624 can suggest multiple tab groups, each with two or more semantically related browser tabs 622. The tab group interface 624 may be a tabbed interface. The tab group interface 624 includes an all tab section 624a and an organizer tab section 624b. The all tab section 624a may identify all browser tabs 622 opened on a user device. The organizer tab section 624b may identify multiple tab groups as tab group suggestions such as a tab group 616-1, a tab group 616-2, and a tab group 616-3. The tab group interface 624 may identify the number of tab groups that are suggested.

In response to the user selection of a callout affordance, a tab manager (e.g., the tab manager 110 of FIGS. 1A to 1G) may initiate (e.g., invoke, execute, activate, etc.) a tab organizer (e.g., the tab organizer 152), which causes a display of the tab group interface 624. As shown in FIG. 6A, the tab group interface 624 may identify multiple tab groups as suggestions to the user, where each tab group includes related browser tabs 622. Each tab group may be separate UI objects or cards. For each tab group, the tab group interface 624 identifies a label 618 and two or more semantically related browser tabs 622 associated with a respective tab group. The label 518 may include a short description of the tab group 516, and, in some examples, an icon that represents the content of the tab group 516. For each tab group, the tab group interface 624 may include an edit control 644. The edit control 644, when selected, is configured to enable the user to edit a respective label 518. In some examples, the edit control 644, when selected, is configured to render an input field to modify the description and/or icon of a respective label 618. For each tab group, the tab group interface 624 includes a dismiss control 646. The dismiss control 646, when selected, is configured to remove a respective tab group from tab group creation.

The tab group interface 624 includes a create control 626 for creating the tab groups in a tab strip. The create control 626, when selected, is configured to modify the tab strip to include the tab groups. The tab group interface 624 includes a clear control 663. The clear control 663 may be configured to undo the tab grouping, e.g., to delete the grouping and restore the previous tab strip indices of the grouped tabs 622. As shown in FIG. 6B, in response to detection of a cursor 660 in a location within a boundary of a tab 622 identified in the tab group interface 624, the tab group interface 624 may display a dismiss control 648 with respect to the tab 622. The dismiss control 648, when selected, is configured to remove the tab 622 from the tab group 616-1.

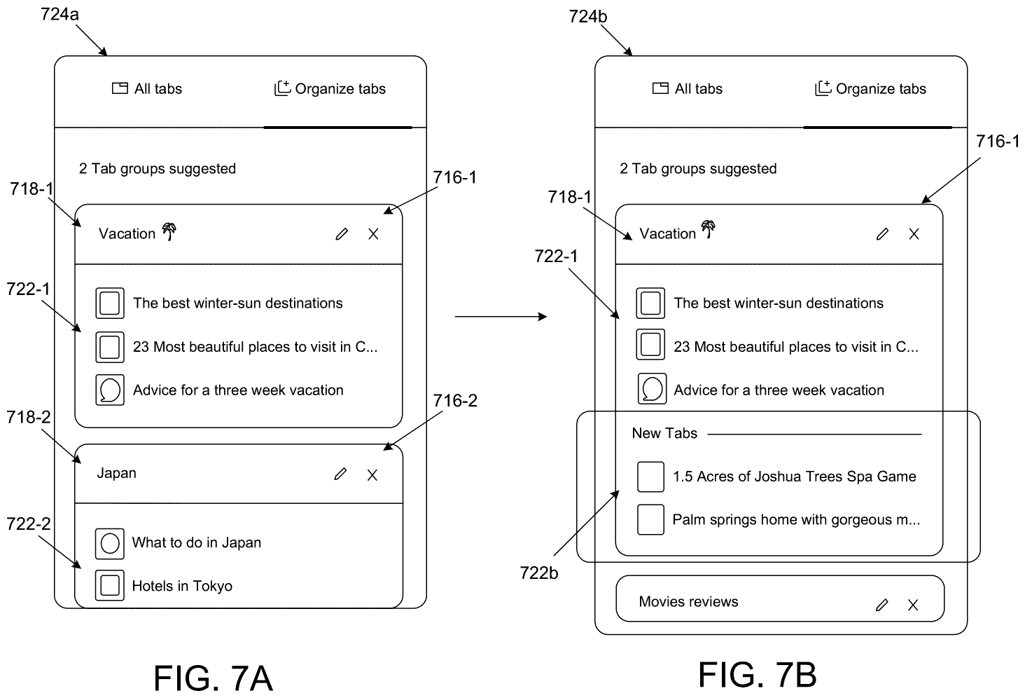

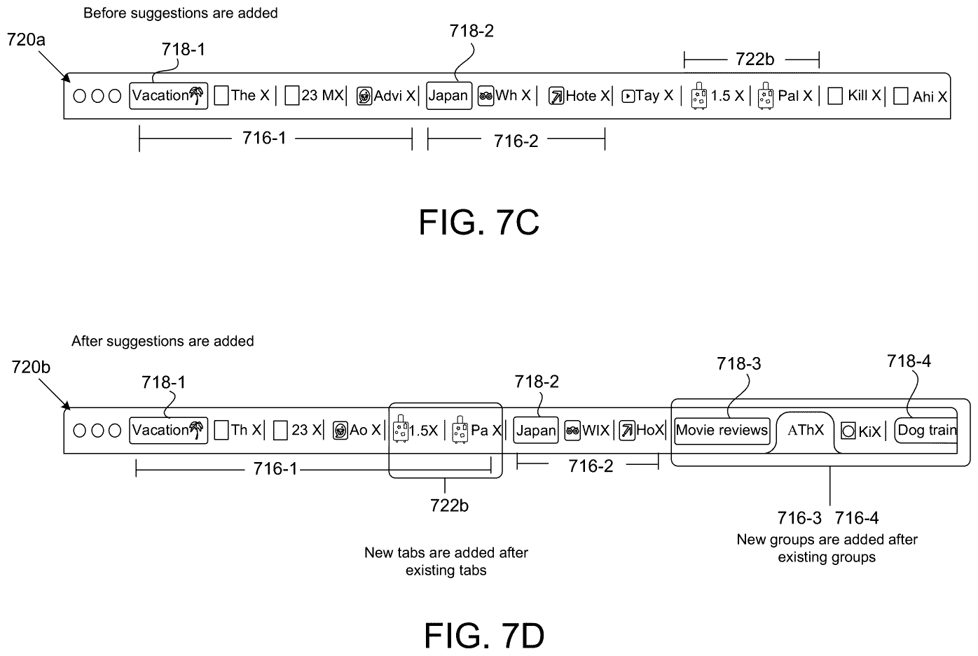

FIGS. 7A to 7D illustrate an example of a tab group interface (e.g., a tab group interface 724a and a tab group interface 724b) and a tab strip (e.g., tab strip 720a and tab strip 720b) according to an aspect. As shown in FIG. 7A, the tab group interface 724a can suggest multiple tab groups such as a tab group 716-1 and a tab group 716-2. The tab group interface 724a includes an all tab section and an organizer tab section. The all tab section may identify all browser tabs opened on a user device. The organizer tab section may identify multiple tab groups as tab group suggestions. The tab group interface 724a may identify the number of tab groups that are suggested. For the tab group 716-1, the tab group interface 724a identifies a label 718-1 and related tabs 722-1. For the tab group 716-2, the tab group interface 724a identifies a label 718-2 and related tabs 722-2.

The user may accept the tab group suggestions, and these tab groups may be created. Then, the user may continue to open browser tabs, including new tabs 722b, after the initial set of tab groups have been created. In response to the user selection of a callout affordance after the initial set of tab groups have been created, a tab manager (e.g., the tab manager 110 of FIGS. 1A to 1G) may initiate (e.g., invoke, execute, activate, etc.) a tab organizer (e.g., the tab organizer 152), which causes a display of the tab group interface 724b.

As shown in FIG. 7B, the service may determine that new tabs 722b are related to the tab group 716-1, and the tab group interface 724b may identify any new tab groups, including a tab group 716-3 (with a corresponding label 718-3) and a tab group 716-4 (with a corresponding label 718-4). As shown in FIG. 7C, a tab strip 720a includes the initial tab groups from FIG. 7A and the new tabs before the tab group suggestions in FIG. 7B are created. For example, the tab strip 720a may identify the label 718-1 and the browser tabs 722-1 of the tab group 716-1, and the label 718-2 and the browser tabs 722-2 of the tab group 716-2, which is followed by the new tabs, including tabs 722b.

As shown in FIG. 7D, after the tab group suggestions in FIG. 7B are added, the new tabs 722b are added after the existing tabs of the tab group 716-1 in the tab strip 720b. In tab strip 720b, existing tab group 716-2 follows the tab group 716-1. After the existing tab groups, the tab strip 720b identifies the new tab groups, including tab group 716-3 (with label 718-3) and tab group 716-4 (with label 718-4).

In FIGS. 7C and 7D, the browser tabs each include an icon and/or text, and in the figures include an icon and some text, but not the full text of the name of the browser tab. The text is truncated by the browser application 108 because of the limited display space available to display of each browser tab. The display of the browser tabs of the tab group together in the tab strip 720a, 720b with a label for the tab group produces the technical benefit of assisting the user in finding a tab of interest even though the browser has truncated the name of the tab when displaying it due to limited display area. This can allow the user more readily to find a tab of interest even if the browser is displaying many tabs, each with a relatively small amount of display area allocated for icons and/or text. Although the labels occupy some space in the tab strip 720a, 720b, thus reducing the amount of display space available for each browser tab, it has been observed that the grouping of the tabs together allows users to find (and select) tabs of interest more quickly.

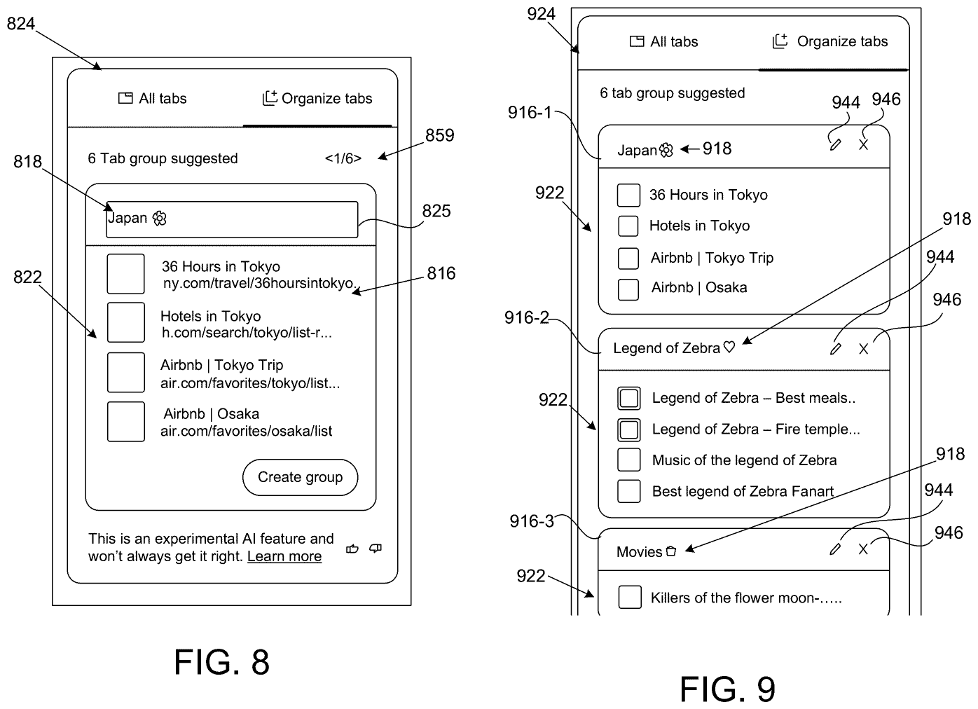

FIG. 8 illustrates an example of a tab group interface 824 according to another aspect. In some examples, the tab group interface 824 suggests multiple tab group 816, each with a label 818 and two or more semantically related browser tabs 822. In some examples, the label 818 is displayed within an editable input field 825. The tab group interface 824 may identify the number of tab groups 816 as tab suggestions. The tab group interface 824 includes navigation controls 859 that, when selected, cause the tab group interface 824 to transition to other tab groups 816.

FIG. 9 illustrates an example of a tab group interface 924 according to another aspect. In some examples, the tab group interface 924 can suggest multiple tab groups, each with two or more semantically related browser tabs 922. The tab group interface 924 may identify multiple tab groups as tab group suggestions such as a tab group 916-1, a tab group 916-2, and a tab group 916-3. The tab group interface 924 may identify the number of tab groups that are suggested.

In response to the user selection of a callout affordance, a tab manager (e.g., the tab manager 110 of FIGS. 1A to 1G) may initiate (e.g., invoke, execute, activate, etc.) a tab organizer (e.g., the tab organizer 152), which causes a display of the tab group interface 924. As shown in FIG. 9, the tab group interface 924 may identify multiple tab groups as suggestions to the user, where each tab group includes related browser tabs 922. Each tab group may be separate UI objects or cards. For each tab group, the tab group interface 924 identifies a label 918 and two or more semantically related browser tabs 922 associated with a respective tab group. The label 918 may include a short description of a respective tab group, and, in some examples, an icon that represents the content of a respective tab group. For each tab group, the tab group interface 924 may include an edit control 944. The edit control 944, when selected, is configured to enable the user to edit a respective label 918. In some examples, the edit control 944, when selected, is configured to render an input field to modify the description and/or icon of a respective label 918. For each tab group, the tab group interface 924 includes a dismiss control 946. The dismiss control 946, when selected, is configured to remove a respective tab group from tab group creation.

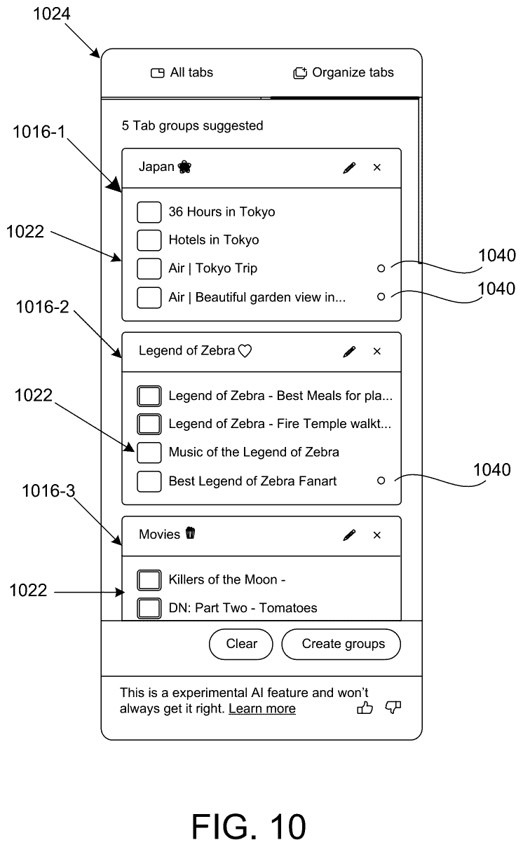

FIG. 10 illustrates an example of a tab group interface 1024 according to another aspect. In some examples, the tab group interface 1024 can suggest multiple tab groups, each with two or more semantically related browser tabs 1022. The tab group interface 1024 may identify multiple tab groups as tab group suggestions such as a tab group 1016-1, a tab group 1016-2, and a tab group 1016-3. The tab group interface 1024 may identify the number of tab groups that are suggested.

In response to the user selection of a callout affordance, a tab manager (e.g., the tab manager 110 of FIGS. 1A to 1G) may initiate (e.g., invoke, execute, activate, etc.) a tab organizer (e.g., the tab organizer 152), which causes a display of the tab group interface 1024. As shown in FIG. 10, the tab group interface 1024 may identify multiple tab groups as suggestions to the user, where each tab group includes related browser tabs 1022. Each tab group may be separate UI objects or cards. For each tab group, the tab group interface 1024 identifies a label and two or more semantically related browser tabs 1022 associated with a respective tab group. The label may include a short description of a respective tab group, and, in some examples, an icon that represents the content of a respective tab group. For each tab group, the tab group interface 1024 may include a visual indicator 1040 associated with one or more browser tabs 1022 in one or more tab groups.

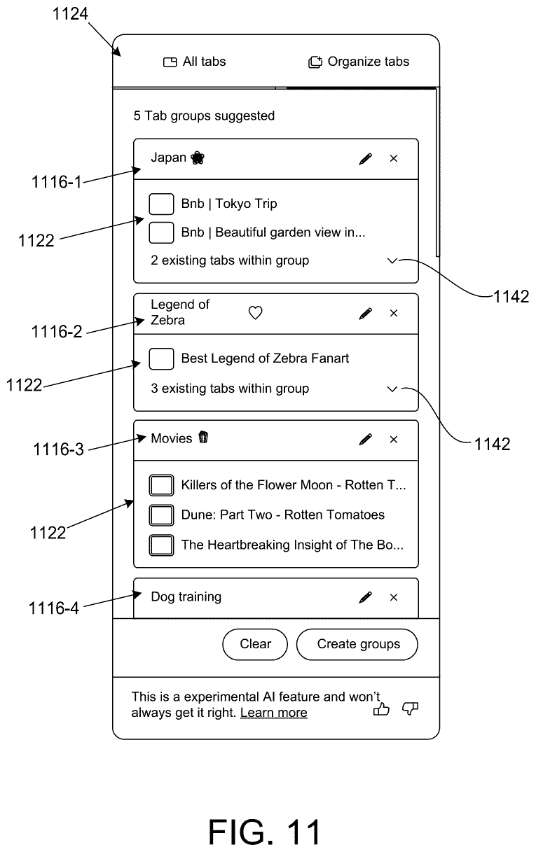

FIG. 11 illustrates an example of a tab group interface 1124 according to another aspect. In some examples, the tab group interface 1124 can suggest multiple tab groups, each with two or more semantically related browser tabs 1122. The tab group interface 1124 may identify multiple tab groups as tab group suggestions such as a tab group 1116-1, a tab group 1116-2, a tab group 1116-3, and a tab group 1116-4. The tab group interface 1124 may identify the number of tab groups that are suggested.

In response to the user selection of a callout affordance, a tab manager (e.g., the tab manager 110 of FIGS. 1A to 1G) may initiate (e.g., invoke, execute, activate, etc.) a tab organizer (e.g., the tab organizer 152), which causes a display of the tab group interface 1124. As shown in FIG. 11, the tab group interface 1124 may identify multiple tab groups as suggestions to the user, where each tab group includes related browser tabs 1122. Each tab group may be separate UI objects or cards. For each tab group, the tab group interface 1124 identifies a label and two or more semantically related browser tabs 1122 associated with a respective tab group. The label may include a short description of a respective tab group, and, in some examples, an icon that represents the content of a respective tab group. For one or more tab groups, the tab group interface 1124 may include an expander control 1142. The expander control 1142, when selected, is configured to identify additional browser tabs 1122 associated with a respective tab group.

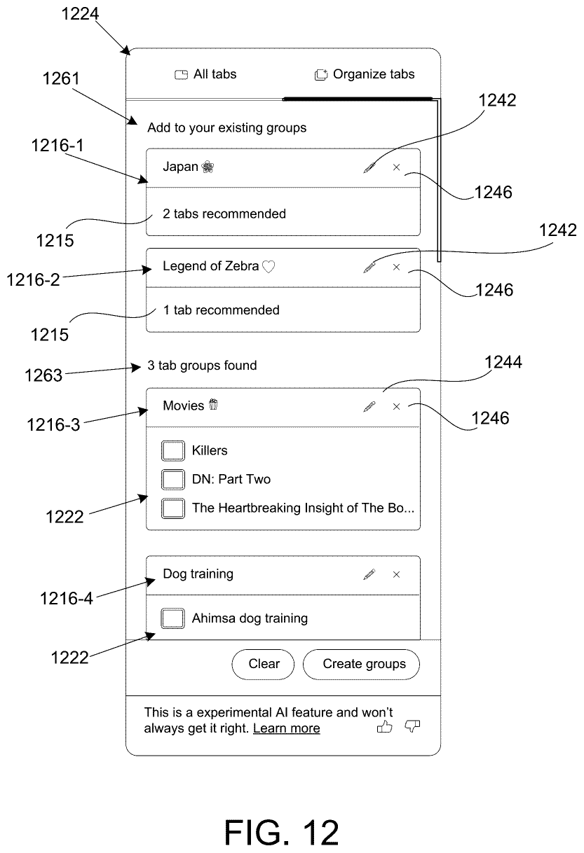

FIG. 12 illustrates an example of a tab group interface 1224 according to another aspect. In some examples, the tab group interface 1224 can suggest multiple tab groups, each with two or more semantically related browser tabs 1222. The tab group interface 1224 may identify multiple tab groups as tab group suggestions such as a tab group 1216-1, a tab group 1216-2, a tab group 1216-3, and a tab group 1216-4. In some examples, the tab group interface 1224 may be rendered after one or more tab groups have already been created. The tab group interface 1224 includes an existing group section 1261 that identifies existing tab groups (e.g., created before the tab group interface 1224 is rendered) and new related (but ungrouped) browser tabs associated with a respective existing tab group. The existing tab groups include tab group 1216-1 and tab group 1216-2. With respect to each of the tab group 1216-1 and the tab group 1216-2, the tab group interface 1224 identifies a recommended tab item 1215, which, when selected, displays one or more browser tabs that are recommended to be part of a respective tab group. The tab group interface 1224 includes a new group tabs section 1263 that identifies any new tab groups, including tab group 1216-3 and tab group 1216-4.

For each existing tab group, the tab group interface 1224 may include an expander control 1242, which, when selected, displays identification of the tabs 1222 associated with the corresponding tab group. For each existing tab group, the tab group interface 1224 includes a dismiss control 1246. The dismiss control 1246, when selected, is configured to remove a respective tab group from tab group creation. For each new tab group, the tab group interface 1224 includes an edit control 1244. The edit control 1244, when selected, is configured to enable the user to edit a respective label. In some examples, the edit control 1244, when selected, is configured to render an input field to modify the description and/or icon of a respective label. For each new tab group, the tab group interface 1024 includes a dismiss control 1246. The dismiss control 1246, when selected, is configured to remove a respective tab group from tab group creation.

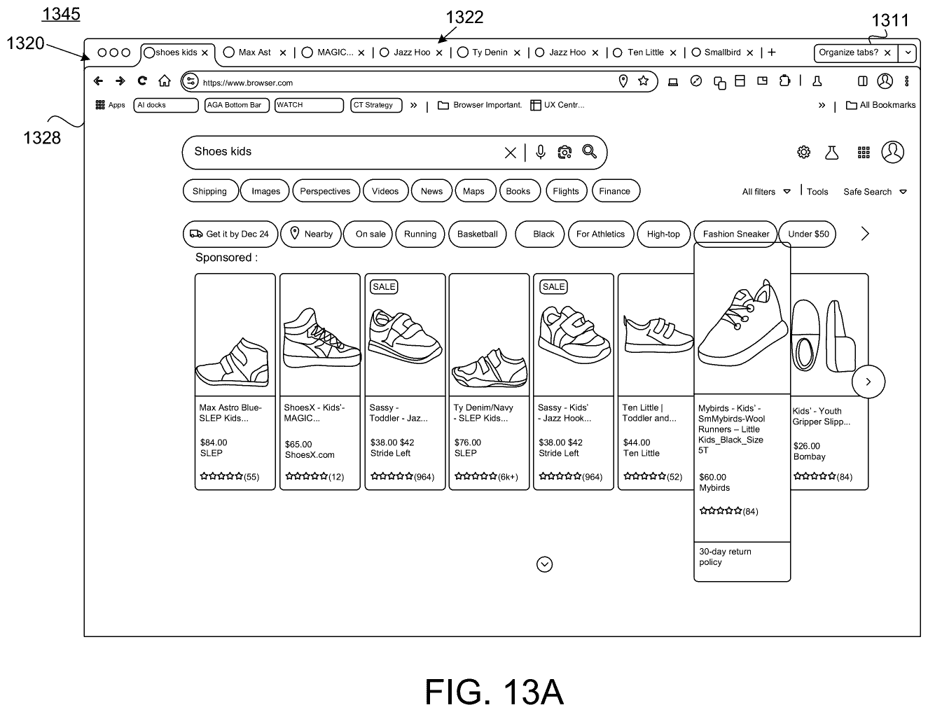

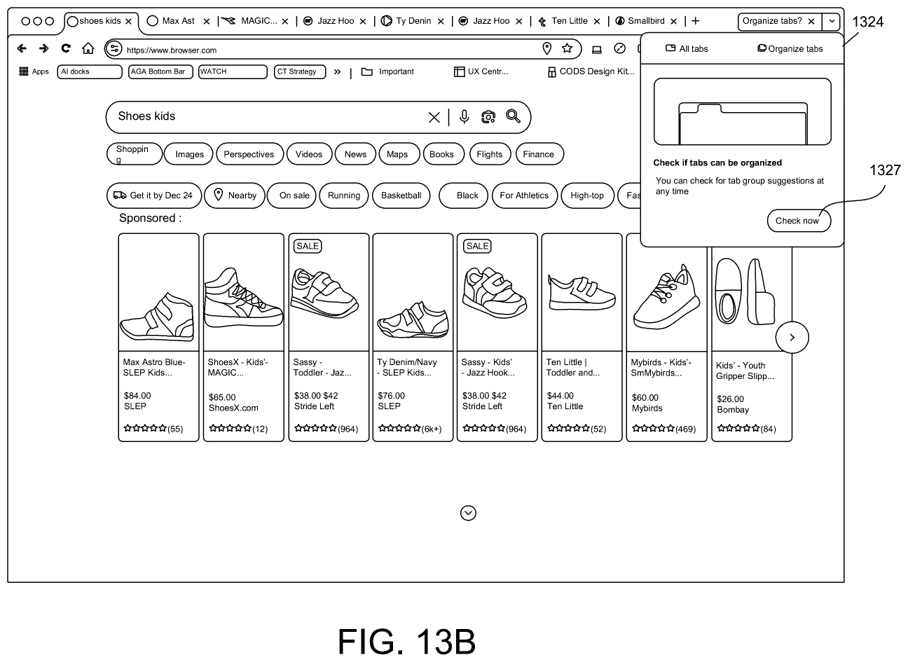

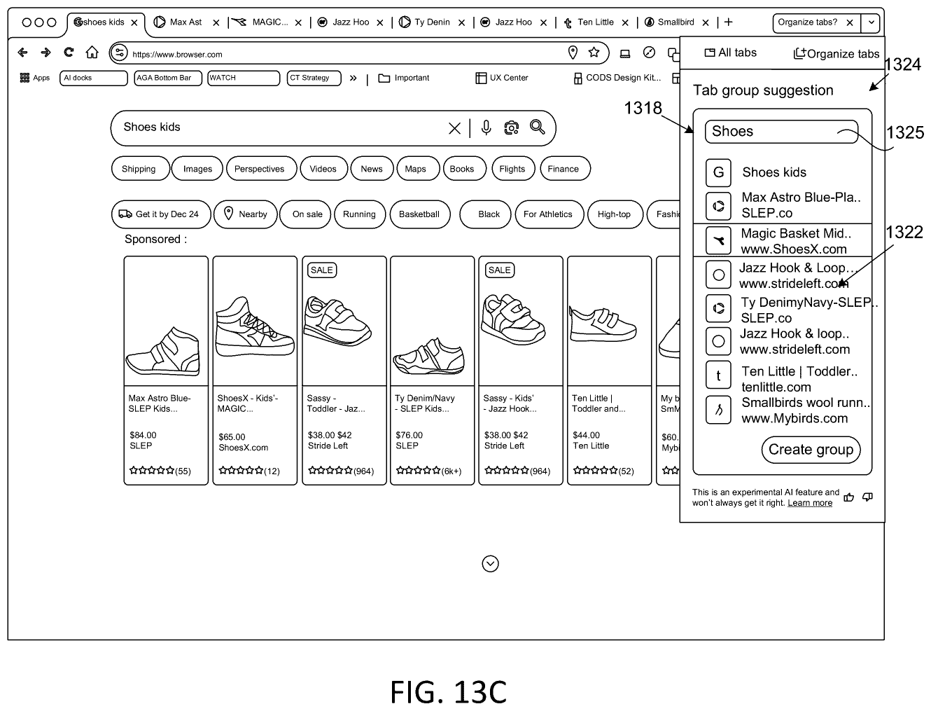

FIGS. 13A to 13C illustrate a user interface 1345 of a browser window 1328 with a plurality of browser tabs 1322 and a user affordance 1311 that initiates a tab organization service. As shown in FIG. 13A, the user affordance 1311 may be proactively rendered according to any of the techniques discussed herein. In response to selection of the user affordance 1311 on a tab strip 1320 in FIG. 13A, a tab group interface 1324 is displayed, as shown in FIG. 13B. As shown in FIG. 13B, the tab group interface 1324 may include a control 1327, which, when selected, causes the tab group interface 1324 to be updated with a tab group suggestion. As shown in FIG. 13C, the tab group suggestion identifies a label 1318 in a label field 1325, and a plurality of related tabs 1322.

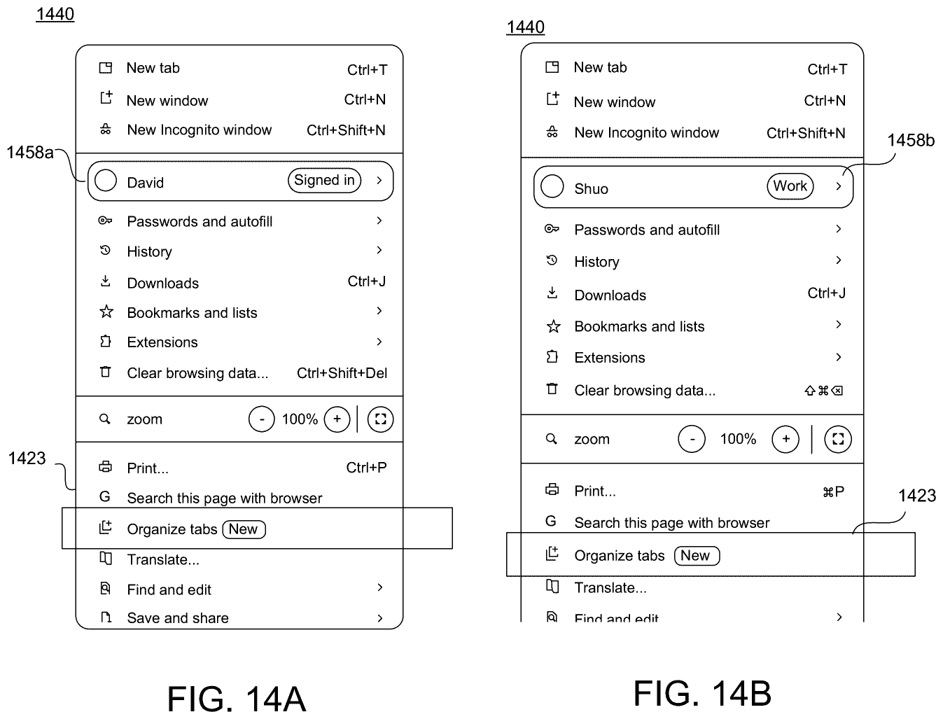

FIGS. 14A and 14B illustrate a browser menu 1440 with a plurality of browser menu items including an organize control 1423 for invoking a tab organization service. The organize control 1423 may be a menu option for an unmanaged profile 1458a as shown in FIG. 14A or a managed profile 1458b of FIG. 14B.

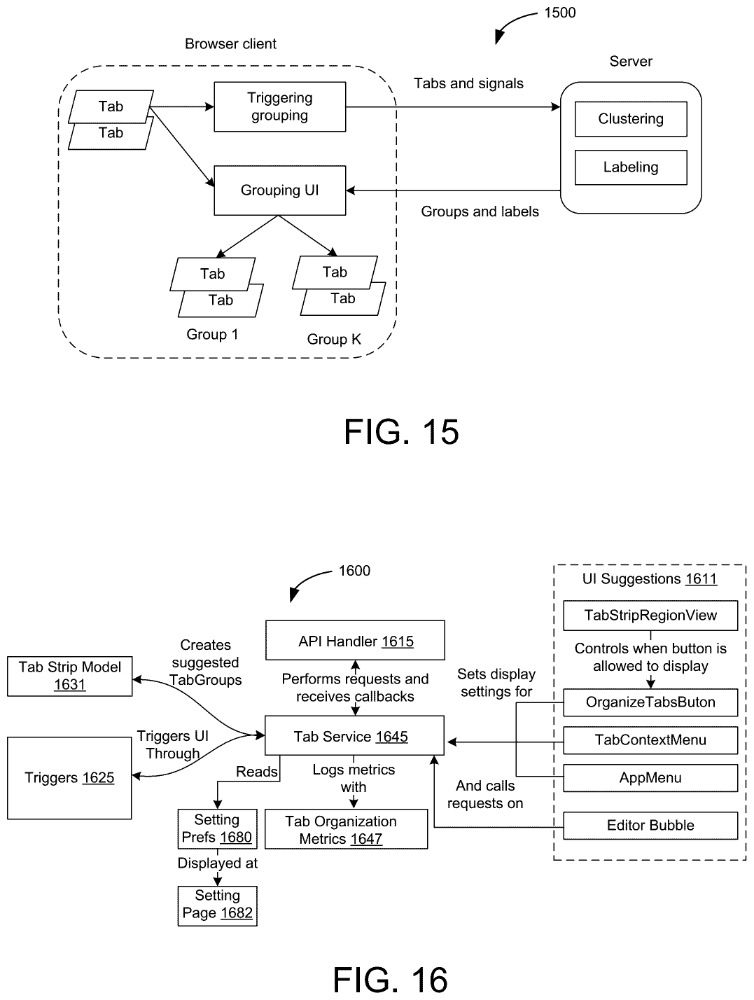

FIG. 15 illustrates a high-level diagram of a system 1500 for implementing a tab organization service according to an aspect. The tab organization service may be an example of the tab organization service 145 of FIGS. 1A to 1G and may include any of the details discussed with reference to those figures. In the example system of FIG. 15, the browser client (on a user computing device that includes a processor, memory, input-output devices, an operating system, etc.) triggers the grouping feature, e.g., initiating the process for generating tab groups and showing a UI element for organizing related tabs in the UI (e.g., a callout affordance 111 of FIGS. 1A to 1G), based on a predefined set of conditions such as browsing activities and contents, as described herein.

In some examples, the user may request the process for generating tab groups expressly, e.g., via a menu option (e.g., a browser menu or tab context menu, etc.). In some implementations, if the tab strip is stable (e.g., no changes to the tabs in the tab strip for a given (predetermined) timeframe), the browser (e.g., the browser application 108 of FIGS. 1A to 1G) may prospectively trigger the process for generating tab groups. Such prospective tab groups may not be used until a user has indicated an intent to generate the group, e.g., via selection of a callout affordance. When triggered, the client sends the tabs and their signals (e.g., page content, page titles, URLs, and/or behavior signals) to the server. In some examples, the server then executes algorithms (e.g., clustering) to group the tabs and generate labels, and sends the generated groups back to the client if their qualities (e.g., the cluster quality score for a group) achieve a quality threshold (e.g., are above a threshold level). In some examples, tab group clustering and/or label generation are performed on the user device. Depending on what triggered the process of tab group generation, the browser UI may display a nudge of organizing related tabs, e.g., via a call affordance, and the browser may show the suggested group(s), e.g., as a tab group interface, or may cache the grouping.

The clustering may take into account semantic signals and/or behavior signals. Semantic signals represent the content of the web page (e.g., page content, titles, URLs, main entity extraction, etc.). Semantic Signals measure the content similarity between two tabs, e.g., representing tabs using embedding vectors calculated by a machine-learning (ML) model that projects the content in a vector space where similar contents are placed close to each other. A similarity score between two tabs can then be computed as the dot-product between embedding vectors for the tabs.

Behavior signals represent attributes about the tab within the browser context. These attributes can be based on user behavior in interacting with the tabs, attributes of the tab, and/or attributes of the web pages represented by the tab. Behavior signals can include navigation chains (e.g., a signal indicating that two tabs are in the same navigation chain). In a navigation chain, two tabs may be in the same chain because a first tab was opened from a link in a second tab. However, as the web page associated with the first tab changes, the link between the two tabs weakens. If a non-related web page is opened in the first tab or the second tab (e.g., the user types in a resource locator in the address bar/omnibox, this can be interpreted in the signals as a weak link or may break the navigation chain altogether, so the two tabs are no longer considered to be in the same navigation chain.

Behavior signals can include link clicks, e.g., where one tab is created by clicking a link in the other tab. Behavior signals can include recency (time) signals. Recency signals can include a gap between the last active times of the two tabs, a gap between the tab creation times of the two tabs, and/or whether a tab is created while the other tab is active. Behavior signals can include tab location, or adjacency. For example, distance between the two tabs (based on locations in the tab strip) can be used, where tabs closer in location to each other may be considered more similar.

Behavior signals can include historical tab grouping and browsing signals, e.g., an estimated probability of tab usage relative to the other tab. For example, if a user has historically opened tabs or grouped tabs in the same vertical/category/domain together, tabs matching that vertical/category/domain pairing may have a higher similarity. Any attributes about the web site represented by tabs historically grouped or opened together can be used in an embedding to determine whether tabs (e.g., the web pages associated with the tabs) in the current tab strip should be grouped together. Behavior signals can include bookmarking signals, e.g., where tabs are similar when they are both in the same bookmark sub-folder. Behavior signals can include a domain, where two tabs are similar when they are in the same domain.

In some implementations, a clustering algorithm may generate clusters using semantic signals and another clustering algorithm may generate clusters using behavior signals. The cluster quality can determine which of these clusters are selected. In some implementations, a clustering algorithm may use both types of signals. The system may define the set of signals between a pair of tabs. The signals, semantic or behavior-related, can be used to compute a similarity/linkage score between two tabs, e.g., via a machine learning model. The system may then cluster the groups (e.g., via clustering algorithms) based on the tab similarity scores.

For example, given a representation of each tab requested to be clustered, the clustering algorithm may compute the pairwise similarity scores for all pairs of tabs. With the similarity scores, the system may use an unsupervised clustering algorithm to assign each tab to at most one group, i.e., so that each suggested group includes a subset of tabs. Implementations can leverage various clustering algorithms, such as Affinity Propagation, DBSCAN, Agglomerative Clustering, among others. Typically, the clustering process involves iteratively merging tabs into groups/clusters. In some implementations, the system may provide the ability to generate clusters that shuffle the prioritization, or weights, of the clustering algorithm between the two signal types (semantic and behavioral). This may allow for clusters to be generated with different structures-some based mostly on semantic signals and some based on behavior signals. This would enable the UI (e.g., tab group interface) to allow the user to request re-clustering or variations of the clustering that best fits their tab group preferences.

In some implementations, the system may use a generative model (e.g., a language model) to generate clusters. For example, the tabs and signals may be provided to a language model with the prompt to group (or cluster) the tabs. In some implementations, the language model could be prompted to recommend clusters on behavior signals or on semantic signals, or to weight behavior signals more than semantic signals, weight them equally, or to weigh semantic signals more than behavior signals. In some implementations, the language model may provide the proposed groups in a JSON format.

For each cluster, the system may estimate the quality of a cluster based on several criteria, which may limit the number of tab groups the user may be unsatisfied with. The score may be based on the overall cluster similarity. The score may be based on the size of the cluster, The score may be based on a weighting based on the core topic of the cluster determined by the page content. The score may be based on two or more of these factors. Clusters that have a quality score that fails to meet a quality threshold may be discarded.

The system may also generate one or more human-readable labels that may be presented to the user for each cluster that has a sufficient quality score. The label generation may use a language model that takes several signals about the tabs within the group as input in order to generate the labels. The signals about the tabs can include content signals, such as tab domain and URL, tab page title, tab page content, an indication of whether or not the tab content includes form fields, a count of images on the web page, and/or an indication of whether the cluster was created primarily on content signals. The behavior signals may include an indication of whether the tab group was created primarily based on behavior signals.

In some implementations, and with user consent, the signals may include user history signals, e.g., whether this user has selected an emoji as the label more often than words or whether the user has selected more generalized suggestions (e.g., travel) over more specialized suggestions (e.g., hotels). These history signals can be stored, with user permission, in local user profile data. The language model may output a structure label that will ensure it fits within the tab Group UI (e.g., is one or two words, less than four words, etc.). The language model, based on the potential input contexts may also provide an emoji as part of the label or as a separate label. The language model may be fine-tuned (specially trained) to meet the required output structure. In some implementations, a single call to the language model may generate several candidate labels for the cluster. These suggested labels may be provided in an ordered list, as discussed herein.

Although not illustrated in FIG. 15, the browser client can include local user profile data. With user permission, the browser may store user history that can help personalize when the callout affordance is proactively suggested, which label is most highly ranked, how clusters are rated, etc. For example, the language model that generates the labels may be provided with user history context that biases the model to score more highly label suggestions that are in line with label suggestions the user has previously selected.

FIG. 16 illustrates a data diagram of an example system 1600 for generating tab group suggestions, according to an implementation. In the example of FIG. 16, a tab service 1645 may function as the central coordinator for the tab organization service (e.g., the tab organization service 145 of FIGS. 1A to 1G) (e.g., the service). The tab service 1645 may be responsible for detecting triggers and logging trigger occurrences. A collection of different triggers 1625 may call into (e.g., invoke, activate, etc.) the tab service 1645 to notify that a trigger action has occurred. In some examples, the tab service 1645 may compute a decision and log metrics with tab organization metrics 1647. The tab service 1645 may be responsible for controlling visibility/enabled state of UI elements. For example, the tab service 1645 may determine when to show suggestion UIs 1611. The tab service 1645 may create and store organization sessions. For example, when initiated, the tab service 1645 may create organization sessions, which are mapped to the browser window they were initiated on. In some examples, the tab organization service may be activated or deactivated via setting preferences 1680 (e.g., browser settings), which can be displayed via a setting page 1682.

When a suggestion is requested, the tab service 1645 may create an organization session structure. In some implementations, the backend response data may be in the form of an array of suggested groups. Each suggested group may have a plurality of properties such as tab identifiers (e.g., tab ids), suggested labels, and metadata to associate the server/client data together. The tab identifiers (e.g., tab ids) may be an array of integers or other identifiers representing the identifiers of the tabs that the group is associated with. The suggested labels may be an array of strings representing the labels generated for the group. The metadata may be an integer representing a unique identifier for the group. The response data may be used to populate a list of suggested groups for the user to choose from. The response data may be converted after being received from an API handler 1615 into mutable objects stored in the service which may include the extra data needed to perform user actions like changing the name to a different suggested name or accepting/rejecting the suggestion. The mutable data object for tabs can be a tab data object. The tab data object may represent the tab in the suggested group and include data from the original state (e.g., what was in the tab strip when the request for generating tab groups was started. A tab data object may contain an identifier to correlate with the actual web contents object contained by the tab. In some examples, the identifier may be derived from the tab identifier object. The tab data object may contain the original URL when the request was created, which can be used to check if the tab should be added to the group after the suggestion is shown to the UI.

The original URL can also be used for checking validity of the tab if it is updating the URL during the transition from suggested group to actual group in the tab strip, the tab service 1645 may remove the tab from the grouping actions. The tab data object may contain the original index of the tab when the request was created which may be used to attempt to revert the tab back to a position it was in before the suggested group was added to the tab strip. If the tab index is invalidated that means the tab strip has been mutated in a way where the system cannot revert the tab to its original state. The tab data object may contain the source context for the tab; in an implementation that pulls tabs from other browser windows, the tab data may keep a reference to the browser window the tab was in before the request was created.

The API handler 1615 may be responsible for adjusting the request parameters from the tab service 1645 into the correct proto structures (e.g., protos) and then sending the request to the intelligence backend. The intelligence backend may be on a server, e.g., the service computer(s) 160 of FIGS. 1A to 1G and/or the server of FIG. 15. The intelligence backend can be on-device, e.g., the user device 102 and/or the browser client of FIG. 15. The intelligence backend includes the clustering and labeling intelligence. When requesting suggestions, the API handler 1615 may take in a callback which may be called on request completion. The intelligence backend may take in a list of potentially groupable tabs, create one or more clusters, and return that to the user device. Once the API handlers 1615 receives the results, it may parse them, and call the response callback provided by the tab service 1645 with the request token.

In some implementations, a ta b strip model 1631 may be a source for the tabs that are in a browser window. A tab strip model 1631 may own a single tab group model which owns the groups that are in the tab strip. When suggesting a group, the tab service 1645 may create a tab group on the tab group model in the browser window (e.g., the browser window that initiating the tab group suggestion). In some examples, this may move the tabs to an edge of the tab strip (e.g., a leading edge or a trailing edge). The tab service 1645 may then create a group containing all of the tabs with the first suggested group label.

When the service's suggestion API completion callback occurs, the tab service 1645 may create the first group in the suggestion model. First it may validate that the tabs are still groupable (if the URL changes or the tab disappears, that tab should not be included in the group, and that may also invalidate the grouping suggestion). The tab service 1645 may then call move and set group on the tab strip model 1631 with the corresponding tab indexes which map to the suggested group's tabs and the correct index.

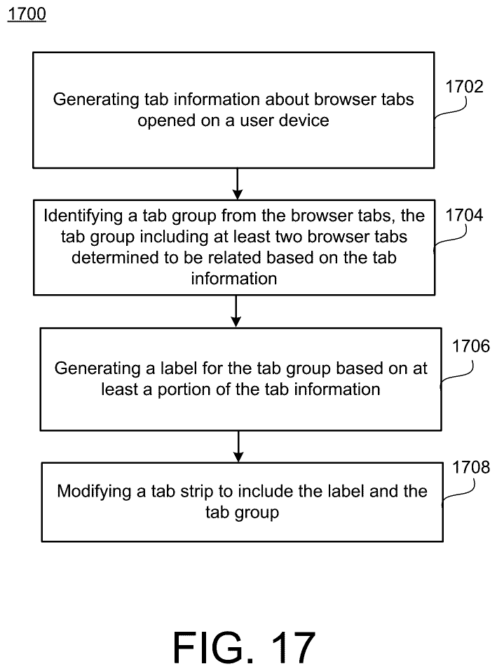

FIG. 17 is a flowchart 1700 depicting example operations of a system for organizing browser tabs using a model according to an aspect. The flowchart 1700 may depict operations of a computer-implemented method. The flowchart 1700 may be applicable to any of the implementations discussed herein. Although the flowchart 1700 of FIG. 17 illustrates the operations in sequential order, it will be appreciated that this is merely an example, and that additional or alternative operations may be included. Further, operations of FIG. 17 and related operations may be executed in a different order than that shown, or in a parallel or overlapping fashion.

Operation 1702 includes generating tab information about browser tabs opened on a user device. In some examples, a browser tab may be replaced with a tab, which would encompass browser tabs and non-browser tab (e.g., any application that can render a tab interface). Operation 1704 includes identifying a tab group from the browser tabs, the tab group including at least two browser tabs determined to be related based on the tab information. Operation 1706 includes generating a label for the tab group based on at least a portion of the tab information. Operation 1708 includes modifying a tab strip to include the label and the tab group.

Clause 1. A method comprising: generating tab information about tabs opened on a user device; identifying a tab group from the tabs, the tab group including at least two tabs determined to be related based on the tab information; generating a label for the tab group based on at least a portion of the tab information; and modifying a tab strip to include the label and the tab group.

Clause 2. The method of clause 1, further comprising: initiating display of a tab group interface, the tab group interface identifying the tab group and a new tab group, the tab group interface identifying a new tab for inclusion in the tab group, the new tab having been created after creation of the tab group.

Clause 3. The method of clause 1, further comprising: initiating display of a tab group interface, the tab group interface identifying a tab group suggestion, the tab group suggestion including an editable field populated with the label, the tab group suggestion including information that identifies the at least two tabs, the tab group suggestion including a control configured to create the tab group; and in response to selection of the control, modifying the tab strip to include the label and the tab group.

Clause 4. The method of clause 1, wherein identifying the tab group includes: generating embeddings using the tab information; computing similarity scores based on the embeddings; clustering a subset of the tabs based on the similarity scores; and identifying the subset as the tab group.

Clause 5. The method of clause 1, wherein generating the label includes: generating a prompt for a language model, the prompt including at least the portion of the tab information; and receiving a model response from the language model, the model response including the label.

Clause 6. The method of clause 1, wherein generating the label includes: generating one or more words that describes the tab group; and generating an icon that represents the tab group.

Clause 7. The method of clause 1, wherein modifying the tab strip includes: inserting the label into the tab strip; and identifying the tab group in the tab strip proximate to the label, wherein a selection of the label causes the tab group to collapse or expand.

Clause 8. The method of clause 1, further comprising: receiving a selection of an organize control displayed in a browser window that includes at least one of the tabs; and in response to the selection of the organize control, initiating identification of the tab group from the tabs.

Clause 9. The method of clause 1, further comprising: detecting an organization event for the tab strip; and in response to detecting the organization event, displaying a control in the tab strip, the control, when selected, configured to initiate identification of the tab group from the tabs.

Clause 10. The method of clause 9, wherein detecting the organization event includes determining that a suggested group of tabs in the tab strip has a quality score that achieves a quality threshold.

Clause 11. The method of clause 1, wherein the tab information includes page titles and resource locators associated with the tabs.

Clause 12. An apparatus comprising: at least one processor; and a non-transitory computer-readable medium storing executable instructions that cause the at least one processor to execute operations, the operations comprising: generating tab information about tabs opened on a user device; identifying a tab group from the tabs, the tab group including at least two tabs determined to be related based on the tab information; generating a label for the tab group based on at least a portion of the tab information; and modifying a tab strip to include the label and the tab group.

Clause 13. The apparatus of clause 12, wherein the operations further comprise: initiating display of a tab group interface, the tab group interface identifying a tab group suggestion, the tab group suggestion including an editable field populated with the label, the tab group suggestion including information that identifies the at least two tabs, the tab group suggestion including a control configured to create the tab group; and in response to selection of the control, modifying the tab strip to include the label and the tab group.

Clause 14. The apparatus of clause 12, wherein the operations further comprise: generating embeddings using the tab information; computing similarity scores based on the embeddings; clustering a subset of the tabs based on the similarity scores; and identifying the subset as the tab group.

Clause 15. The apparatus of clause 12, wherein the operations further comprise: generating a prompt for a language model, the prompt including at least the portion of the tab information; and receiving a model response from the language model, the model response including the label.

Clause 16. The apparatus of clause 12, wherein the operations further comprising: generating one or more words that describes the tab group; and generating an icon that represents the tab group.

Clause 17. The apparatus of clause 12, wherein the operations further comprising: inserting the label into the tab strip; and identifying the tab group in the tab strip proximate to the label, wherein a selection of the label causes the tab group to collapse or expand.

Clause 18. A non-transitory computer-readable medium storing executable instructions that cause at least one processor to execute operations, the operations comprising: generating tab information about tabs opened on a user device; identifying a tab group from the tabs, the tab group including at least two tabs determined to be related based on the tab information; generating a label for the tab group based on at least a portion of the tab information; and modifying a tab strip to include the label and the tab group.

Clause 19. The non-transitory computer-readable medium of clause 18, wherein the operations further comprise: initiating display of a tab group interface, the tab group interface identifying the tab group and a new tab group, the tab group interface identifying a new tab for inclusion in the tab group, the new tab having been created after creation of the tab group.

Clause 20. The non-transitory computer-readable medium of clause 18, wherein the operations further comprise: initiating display of a tab group interface, the tab group interface identifying a tab group suggestion, the tab group suggestion including an editable field populated with the label, the tab group suggestion including information that identifies the at least two tabs, the tab group suggestion including a control configured to create the tab group; and in response to selection of the control, modifying the tab strip to include the label and the tab group.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A method comprising:
generating tab information about tabs opened on a user device;
identifying a tab group from the tabs, the tab group including at least two tabs determined to be related based on the tab information;
generating a label for the tab group based on at least a portion of the tab information; and
modifying a tab strip to include the label and the tab group.

2. The method of claim 1, further comprising:
initiating display of a tab group interface, the tab group interface identifying the tab group and a new tab group, the tab group interface identifying a new tab for inclusion in the tab group, the new tab having been created after creation of the tab group.

3. The method of claim 1, further comprising:
initiating display of a tab group interface, the tab group interface identifying a tab group suggestion, the tab group suggestion including an editable field populated with the label, the tab group suggestion including information that identifies the at least two tabs, the tab group suggestion including a control configured to create the tab group; and
in response to selection of the control, modifying the tab strip to include the label and the tab group.

4. The method of claim 1, wherein identifying the tab group includes:
generating embeddings using the tab information;
computing similarity scores based on the embeddings;
clustering a subset of the tabs based on the similarity scores; and
identifying the subset as the tab group.

5. The method of claim 1, wherein generating the label includes:
generating a prompt for a language model, the prompt including at least the portion of the tab information; and
receiving a model response from the language model, the model response including the label.

6. The method of claim 1, wherein generating the label includes:
generating one or more words that describes the tab group; and
generating an icon that represents the tab group.

7. The method of claim 1, wherein modifying the tab strip includes:
inserting the label into the tab strip; and
identifying the tab group in the tab strip proximate to the label, wherein a selection of the label causes the tab group to collapse or expand.

8. The method of claim 1, further comprising:
receiving a selection of an organize control displayed in a browser window that includes at least one of the tabs; and
in response to the selection of the organize control, initiating identification of the tab group from the tabs.

9. The method of claim 1, further comprising:
detecting an organization event for the tab strip; and
in response to detecting the organization event, displaying a control in the tab strip, the control, when selected, configured to initiate identification of the tab group from the tabs.

10. The method of claim 9, wherein detecting the organization event includes determining that a suggested group of tabs in the tab strip has a quality score that achieves a quality threshold.

11. The method of claim 1, wherein the tab information includes page titles and resource locators associated with the tabs.

12. An apparatus comprising:
at least one processor; and
a non-transitory computer-readable medium storing executable instructions that cause the at least one processor to execute operations, the operations comprising:
generating tab information about tabs opened on a user device;
identifying a tab group from the tabs, the tab group including at least two tabs determined to be related based on the tab information;
generating a label for the tab group based on at least a portion of the tab information; and
modifying a tab strip to include the label and the tab group.

13. The apparatus of claim 12, wherein the operations further comprise:
initiating display of a tab group interface, the tab group interface identifying a tab group suggestion, the tab group suggestion including an editable field populated with the label, the tab group suggestion including information that identifies the at least two tabs, the tab group suggestion including a control configured to create the tab group; and
in response to selection of the control, modifying the tab strip to include the label and the tab group.

14. The apparatus of claim 12, wherein the operations further comprise:
generating embeddings using the tab information;
computing similarity scores based on the embeddings;
clustering a subset of the tabs based on the similarity scores; and
identifying the subset as the tab group.

15. The apparatus of claim 12, wherein the operations further comprise:
generating a prompt for a language model, the prompt including at least the portion of the tab information; and
receiving a model response from the language model, the model response including the label.

16. The apparatus of claim 12, wherein the operations further comprising:
generating one or more words that describes the tab group; and
generating an icon that represents the tab group.

17. The apparatus of claim 12, wherein the operations further comprising:
inserting the label into the tab strip; and
identifying the tab group in the tab strip proximate to the label, wherein a selection of the label causes the tab group to collapse or expand.

18. A non-transitory computer-readable medium storing executable instructions that cause at least one processor to execute operations, the operations comprising:
generating tab information about tabs opened on a user device;
identifying a tab group from the tabs, the tab group including at least two tabs determined to be related based on the tab information;
generating a label for the tab group based on at least a portion of the tab information; and
modifying a tab strip to include the label and the tab group.

19. The non-transitory computer-readable medium of claim 18, wherein the operations further comprise:
initiating display of a tab group interface, the tab group interface identifying the tab group and a new tab group, the tab group interface identifying a new tab for inclusion in the tab group, the new tab having been created after creation of the tab group.

20. The non-transitory computer-readable medium of claim 18, wherein the operations further comprise:
initiating display of a tab group interface, the tab group interface identifying a tab group suggestion, the tab group suggestion including an editable field populated with the label, the tab group suggestion including information that identifies the at least two tabs, the tab group suggestion including a control configured to create the tab group; and
in response to selection of the control, modifying the tab strip to include the label and the tab group.
